(19) United States
(12) Patent Application Publication
(10) Pub. No.: US 2026/0133308 A1
(43) Pub. Date: May 14, 2026

(54) METHODS, ARCHITECTURES, APPARATUSES, AND SYSTEMS FOR DETECTION AND REPORTING OF REFLECTIONS FROM TARGET OBJECT

(71) Applicant: InterDigital Patent Holdings, Inc., Wilmington, DE (US)

(72) Inventors: Mohammad Heggo, Lewisham (GB); Arman Shojaeifard, London (GB); Alain Mourad, Ascot (GB); Remun Koirala, London (GB); Yasser Mestrah, Uxbridge (GB)

(21) Appl. No.: 18/942,125

(22) Filed: Nov. 8, 2024

(51) Int. Cl. G01S 13/46; G01S 7/00; G01S 7/41

(52) U.S. Cl. CPC G01S 13/46; G01S 7/006; G01S 7/411; G01S 2013/462

(57) ABSTRACT

Methods and devices are provided for performing sensing measurements of a target object using a wireless transmit/receive unit (WTRU) in communication with a wireless network. The method comprises receiving configuration information and a sensing reference signal (Sen_RS) with an indication of one or more paths from the network. The WTRU performs measurements based on the Sen_RS and configuration information, determining whether each path is a first type of reflection, such as a single-bounce line-of-sight (LoS), or a second type of reflection, such as a multi-bounce non-line-of-sight (NLoS) reflection. For multi-bounce paths, the degree and type of reflection are identified. This information, including the measurements and reflection types, is then transmitted back to the network. The WTRU is equipped with a processor configured for these tasks.

### TECHNICAL FIELD

The present disclosure is generally directed to the fields of communications, software and encoding, including, for example, methods, architectures, apparatuses, and systems related to a sensing task.

### BACKGROUND

A Logical Channel Prioritization (LCP) procedure involves the scheduling of uplink data by Radio Resource Control (RRC), which sets priorities, prioritized bit rates, and bucket size durations for each logical channel. The RRC also configures mapping restrictions such as allowed subcarrier spacing, maximum Physical Uplink Shared Channel (PUSCH) duration, and allowed serving cells. A Medium Access Control (MAC) entity maintains a variable for each logical channel, incrementing it based on the prioritized bit rate and time elapsed. During new transmissions, the MAC entity selects logical channels that meet specific conditions and allocates resources in decreasing priority order. If resources remain, they are allocated to logical channels in strict priority order. The MAC entity follows specific rules for segmenting Radio Link Control (RLC) Service Data Units (SDUs) and maximizing data transmission, and may skip uplink transmission under certain conditions. However, as regards a sensing task, technical challenges in implementation and effectiveness remain.

### SUMMARY

In certain representative embodiments, methods and wireless transmit/receive units (WTRUs) are provided to communicate with a wireless network to measure a target object. The methods and WTRUs comprise receiving configuration information from the wireless network, receiving a sensing reference signal (Sen_RS) with an indication of one or more paths, and performing measurements based on the Sen_RS signal and the configuration information. For each path, it is determined whether it is a first type of reflection (e.g., a single-bounce line-of-sight (LoS) reflection) or a second type of reflection (e.g., a multi-bounce non-line-of-sight (NLoS) reflection). For the second type of reflection, the degree and type of reflection are identified. This information, including the measurements and reflection types, is then sent back to the wireless network.

For example, the configuration information comprises metrics and conditions to determine the type of reference signal, a measurement window in time or space, and information about objects that scatter the signal. The measurement window can be set in either the time or spatial domain. Metrics and conditions comprise thresholds for the first and second types of reflections. Scatterer information comprises the location, radar cross-section, and delay profile of scattering objects. Determining the type of reflection is based on differences or correlations between the signal and the target object or scatterer profiles. The transmitted information may also comprise measurements within a window, comparison results at specific angles, and resource IDs for reflections. The degree of the second type of reflection can be double, triple, or higher-order, and the type of path can be combinations of direct and indirect paths. Sensing measurements comprise various signal quality and power metrics.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a chart of single-bounce RS path loss, according to one or more embodiments;

FIG. 3 is a diagram of time of flight (ToF) and distance measurement for a single-bounce signal, according to one or more embodiments;

FIG. 4 is a chart of radar cross-section (RCS) versus frequency for a first object (e.g., target) and a second object (e.g., type 2 primary), according to one or more embodiments;

FIG. 5 is a chart of normalized path loss of a double-bounce RS at different frequencies, according to one or more embodiments;

FIG. 6 is a diagram of line of sight (LoS) and/or non-line of sight (NLoS) reflections from a target, according to one or more embodiments;

FIG. 7 is a diagram of target location estimation using reflected RS measurements, according to one or more embodiments;

FIG. 8 is a chart of measured RS received power and a configured RCS profile at different frequencies, according to one or more embodiments;

FIG. 9 is a chart of normalized measured RS received power and a normalized configured RCS profile at different frequencies, according to one or more embodiments;

FIG. 10 is a diagram of target double-bounce RS reflection, according to one or more embodiments; and

FIG. 11 is a flow chart illustrating a method performed by a WTRU in communication with a wireless network for performing sensing measurements of a target object, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

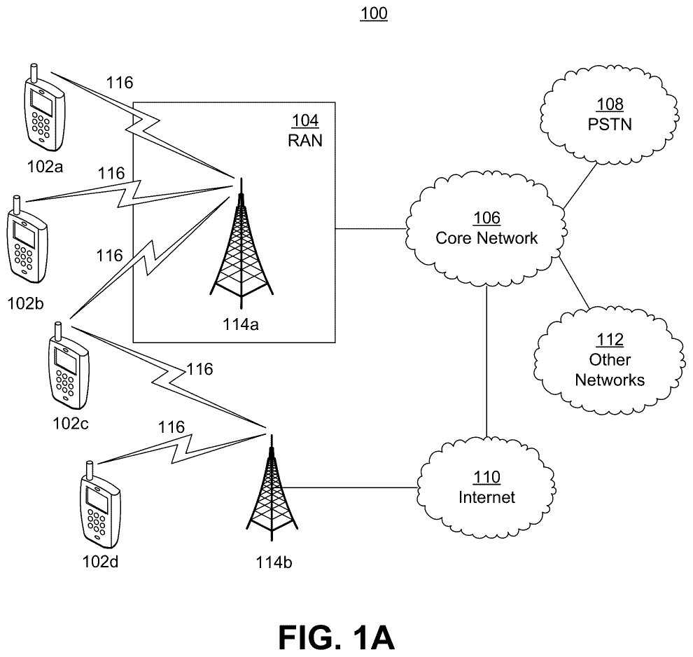

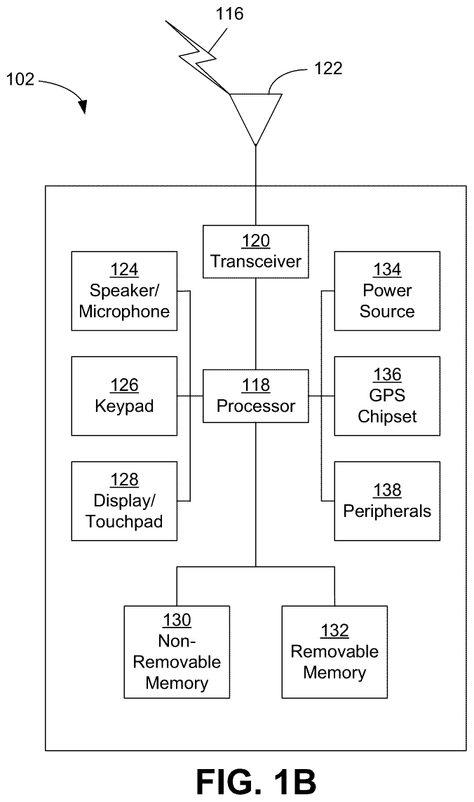

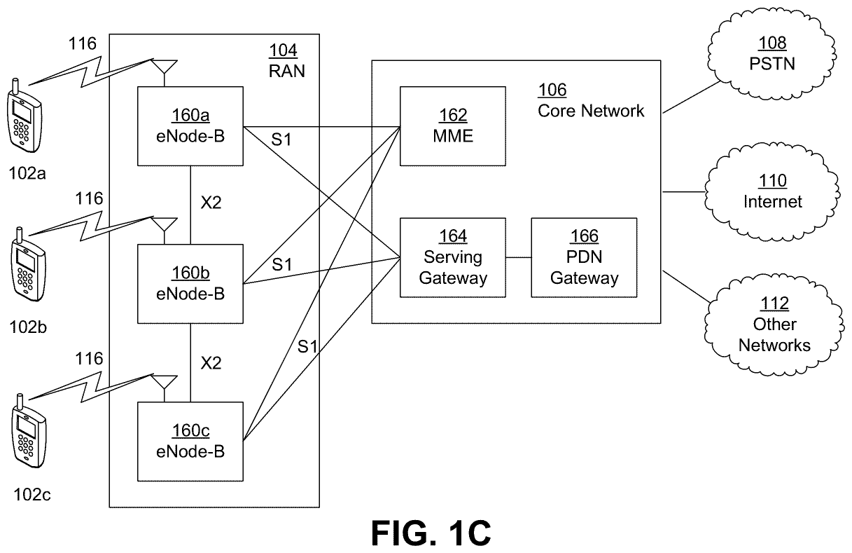

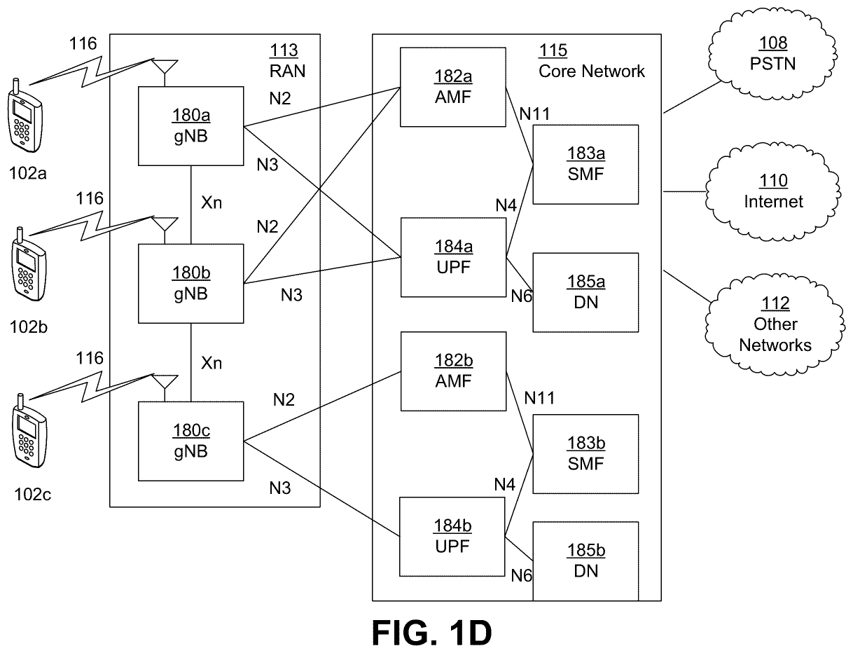

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations (BSs), networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (CNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). The frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of the elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of the component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of the elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (cMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Methods, architectures, apparatuses, and systems for detection and reporting of single-bounce and multi-bounce reflections from a target object (TO) are provided. For example, the detection and the reporting of the single-bounce (SB) and the multi-bounce (MB) reflections from the TO are provided as part of Integrated Sensing and Communication (ISAC). Also, for example, target LoS and/or NLoS reflection detection are provided. Further, for example, target NLoS reflection classification is provided. In addition, for example, target NLoS reflection classification is based on at least one of degree (e.g., double-bounce (DB), triple-bounce (TB), or the like), a type of NLoS with respect to a gNB and/or a WTRU (e.g., gNB-target is NLoS and/or LoS, target—WTRU is NLoS and/or LoS, or the like), combinations of the same, or the like. Moreover, for example, a WTRU determines that received target reflections are single-bounced and/or LoS or multi-bounced and/or NLoS based on at least one of received RS measurements, configured TO profile, scatterer (SC) profile, combinations of the same, or the like. Furthermore, for example, a WTRU determines a degree of target multi-bounce reflection (e.g., double-bounce, triple-bounce, or the like). Additionally, for example, a WTRU determines a type of NLoS reflections from a target (e.g., gNB—target path is NLoS and/or LoS, target—WTRU path is NLoS and/or LoS, or the like). Still further, for example, a WTRU reports to a network one or more LOS and/or NLoS indications that are associated with RS resources (e.g., resolvable) paths that are reflected from a target.

For example, in combination with detection and reporting of single-bounce and multi-bounce reflections from a TO, sensing of objects in the environment is described as follows. For example, the sensing of objects in the environment includes at least one of object detection, tracking, number of sensing objects, clutter characteristics, combinations of the same, or the like. Further, for example, the WTRU receives different types of reflections from the TO such as SB, DB, and/or MB reflections. Moreover, for example, in SB reflection, the TO has a LoS path to both a transmitting/transmitter reference point (TRP) and the WTRU. Additionally, for example, in MB reflection (e.g., DB reflection, TB reflection, or the like), the TO has a NLoS path to the TRP and/or the WTRU.

For example, characteristics of objects (e.g., TOs, SCs, or the like) detected and/or reported by SB and MB reflections are provided. Further, for example, characteristics of objects including at least one of shape, size, material, vibration, rotation, combinations of the same, or the like influence how an incident reference signal is scattered. In one example, the RCS of an object may vary based on at least one of the following characteristics of an incident radio signal: an incidence angle; a scattering angle; an aspect angle (e.g., an average of incidence and scattering angle); a frequency; combinations of the same; or the like. Additionally, for example, a RCS profile (e.g., RCS angular profile, RCS frequency profile, or the like) is defined (e.g., by a WTRU) by a RCS pattern over a range of values of a characteristic of the incident radio signal (e.g., incidence angles, scattering angles, aspect angles, frequencies, combinations of the same, or the like). Similarly, for example, sensing parameter profiles (e.g., RCS profile, micro-doppler (MD) profile, or the like) are defined (e.g., by a WTRU) by a sensing parameter pattern (e.g., RCS, MD, or the like) over a range of values of a characteristic of the incident radio signal. Moreover, for example, similar sensing parameter profiles (e.g., RCS profiles, MD profiles, or the like) are defined (e.g., by a WTRU) for objects that share one or more characteristics (e.g., shape, size, material, vibration, rotation, or the like) relevant to incident reference signal scattering behavior.

For example, characteristics of SB signals (e.g., signals reflected by a TO directly towards the WTRU) detected and/or reported by the WTRU are described. Further, for example, distinctive features of SB signals include at least one of: a path loss frequency profile, a time of flight (ToF) and/or an angle-of-arrival (AoA); a reference signal received power (RSRP), a reference signal received power per path (RSRPP), and/or a reference signal carrier power (RSCP); combinations of the same, or the like. In one example, the WTRU determines the path loss frequency profile based on path loss of a received SB reference signal (RS) at different frequencies. In this example, the path loss frequency profile of the SB RS is similar to the RCS frequency profile of the TO (e.g., through which the SB signal is reflected). In another example, the ToF and/or AoA of the SB RS are dependent on the location of the TO. In a further example, the RSRP, RSRPP, and/or RSCP of the SB RS are dependent on the location and RCS of the TO. Moreover, for example, the WTRU leverages the detected and/or reported features of SB signals to perform at least one of: determining the RCS frequency profile of the TO (e.g., that reflects the SB signal to the WTRU; determining the RS ID associated with the SB signal (e.g., based on a priori knowledge of the target average RCS, target coarse location, combinations of the same, or the like).

For example, characteristics of DB signals (e.g., signals reflected by a TO towards one or more SC object and further bounced towards the WTRU) detected and/or reported by the WTRU are described. Further, for example, distinctive features of DB signals includes a path loss frequency profile of the DB signal. In one example, the WTRU determines the path loss frequency profile based on path loss of a received DB RS at different frequencies. Additionally, for example, the path loss frequency profile is dependent on at least one of: the RCS frequency profile of the target, the RCS profile of a SC object, combinations of the same, or the like. Moreover, for example, the WTRU detects the DB signal associated with the target based on the RCS frequency profiles of the SC objects.

For example, in the detection of SB RSs, the channel gain H_{single} of the received SB RS (e.g., that is only reflected by the TO) is expressed in accordance with equation (1) as follows:

$${H}_{single} = H ( D 1 ) \times {RCS}_{TO} \times H ( D 2 ) \qquad ( 1 )$$

where D1 and D2 are the separation distances of the SC from the TRP and from the WTRU, respectively. H(D1) and H(D2) are the channel gains corresponding to the SB RS propagation for distances D1 and D2, respectively. D1+D2 represent the overall propagation path length of the single-bounce signal (e.g., referred to as the SB path length). RCS_{TO} is the TO radar cross section.

Further, for example, the path loss for the SB RS PL_{dB}^{SB} is calculated (e.g., in decibels (dB)) in accordance with equation (2) as follows:

$${{PL}_{dB}}^{SB} = {PL}_{dB} ( D 1 ) + {PL}_{dB} ( D 2 ) - {RCS}_{TO , dB} \qquad ( 2 )$$

where RCS_{TO,dB} is the TO RCS (e.g., in dB) and PL_{dB}(D1) and PL_{dB}(D1) are the path loss (e.g., in dB) corresponding to the distances D1 and D2, respectively. This equation may be rewritten in accordance with equation (3) as follows:

$${{PL}_{dB}}^{SB} = {{PL}_{dB}}^{SB , dist} - {RCS}_{TO , dB} \qquad ( 3 )$$

where PL_{dB}^{SB,dist} is the path loss component that is dependent on TO separation distances from the TRP and WTRU (e.g., D1 and D2). PL_{dB}^{SB,dist} may be defined as the SB path loss distance component.

In some examples, the WTRU leverages the path loss information to calculate an expected average RSRPP (e.g., average RSRPP over various frequencies) for the TO SB RS. The calculated expected average RSRPP may be based on the calculated SB path length and/or the average RCS for the TO (e.g., provided by the network).

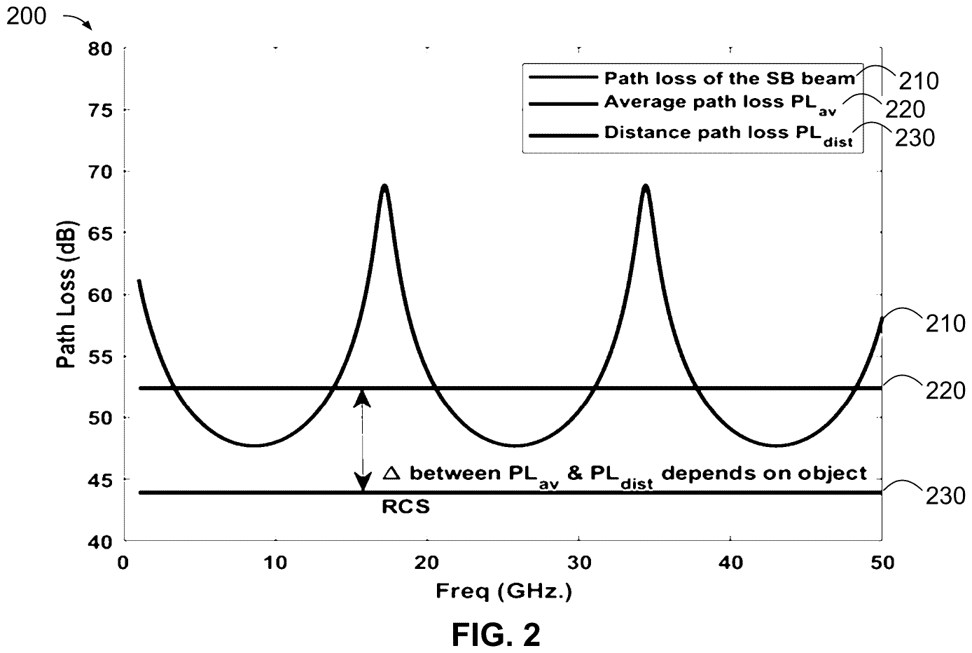

FIG. 2 shows an illustrative chart 200 of SB RS path loss, according to one or more embodiments. As shown in FIG. 2, in some examples, the WTRU calculates an average PLₐᵥ 220 across frequencies of a SB signal path loss 210, e.g., in dB. Further, for example, the WTRU determines a distance path loss PL_{dist} 230 and determines the average RCS of the TO, e.g., based on the difference between PLₐᵥ 220 and PL_{dist} 230.

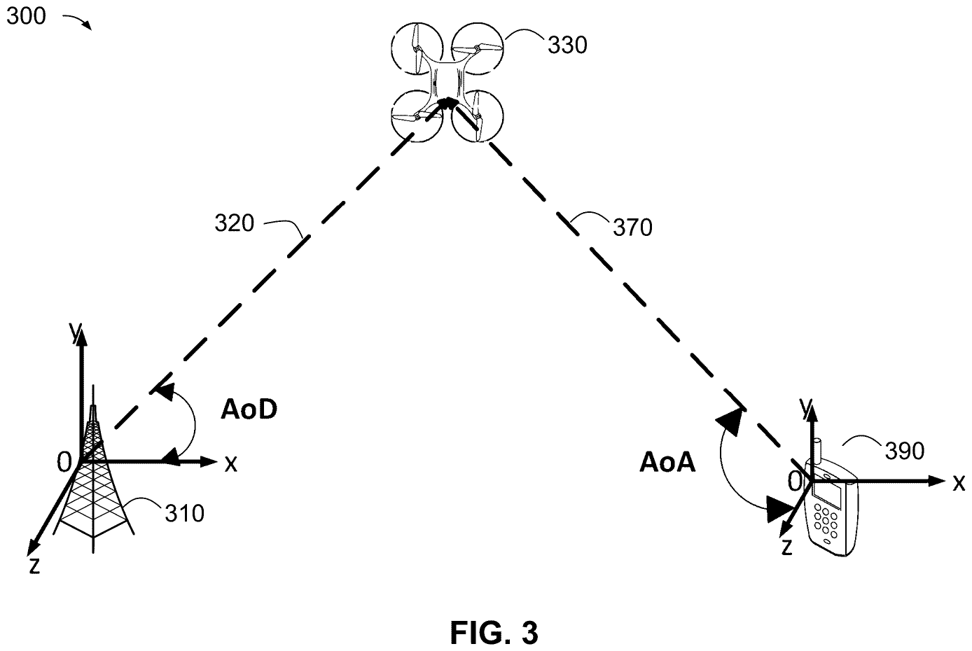

FIG. 3 shows an illustrative example 300 of ToF and distance measurement for a single-bounce signal, according to one or more embodiments. As shown in FIG. 3, in some examples, the WTRU 390 determines a total distance of a SB path (e.g., the sum of distances 320 and 370) and its corresponding ToF, e.g., based on at least one of the measured AoA at the WTRU 390, the angle of departure (AoD) at the TRP 310, the position information of the WTRU 390, the position information of the TRP 310, combinations of the same, or the like. Further, for example, the WTRU determines an expected time of arrival (ToA) for the SB RS that is reflected from the TO 330, e.g., based on the ToF.

In some examples, the WTRU detects a DB and/or MB RS through NLoS reflection, which includes a RS reflected by a TO that is further reflected by one or more SCs in the environment. For example, the channel gain (H^{DB}) for a received DB RS that is reflected by a TO and a SC to the WTRU may be expressed in accordance with equation (4) as follows:

$${H}^{DB} = H ( D 1 ) \times {RCS}_{TO} \times H ( D 2 ) \times {RCS}_{SC} \times H ( D 3 ) \qquad ( 4 )$$

where D1, D2, and D3 are the distances between the TRP and TO, TO and SC, and SC and WTRU, respectively. In this example, H(D1), H(D2), H(D3) are the channel gains for the distances D1, D2, and D3, respectively. RCS_{SC} is the RCS of the SC object. Further, for example, the path loss (PL_{dB}^{DB}) of the DB RS is expressed (e.g., in dB) in accordance with equation (5) as follows:

$${{PL}_{dB}}^{DB} = {PL}_{dB} ( D 1 ) + {PL}_{dB} ( D 2 ) + {PL}_{dB} ( D 3 ) - {RCS}_{TO , dB} - {RCS}_{SC , dB} \qquad ( 5 )$$

where PL_{dB}(D1), PL_{dB}(D2), and PL_{dB}(D3) are the path losses (e.g., in dB) for the distances D1, D2, and D3, respectively. In this example, RCS_{TO,dB} is the RCS of the TO object (e.g., in dB) and RCS_{SC,dB} is the RCS of the SC object (e.g., in dB).

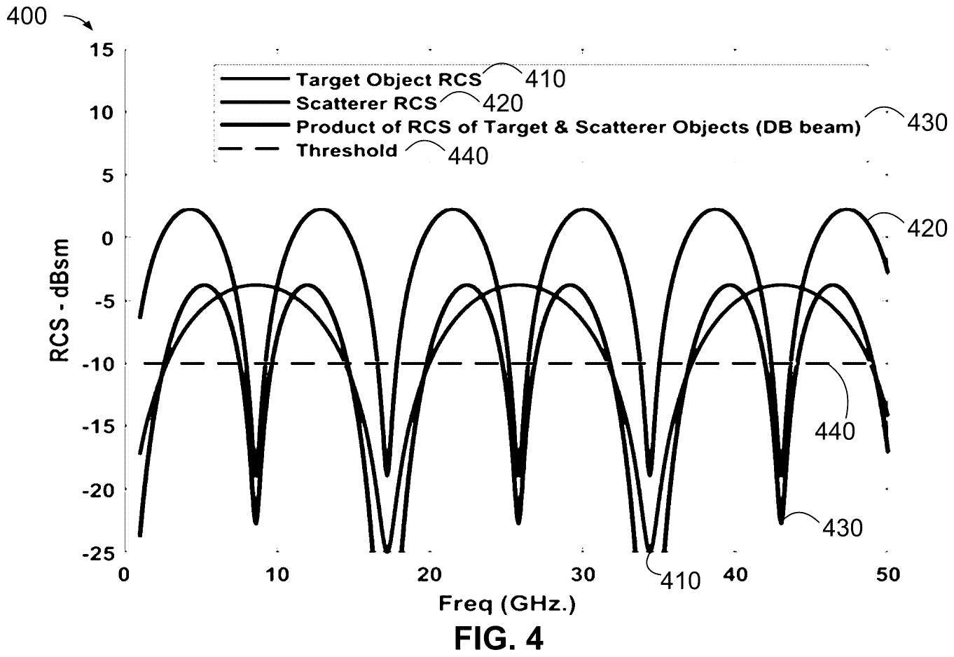

FIG. 4 is an illustrative chart 400 of RCS (e.g., in dBsm) across multiple frequencies (e.g., in GHz) for a TO and an SC, according to one or more embodiments. As shown in FIG. 4, in some examples, the WTRU determines a TO RCS 410 and a SC RCS 420 across multiple frequencies for comparison with a threshold RCS 440. For example, the WTRU further determines a RCS product 430 of the TO RCS 410 and the SC RCS 420 corresponding to the DB beam (e.g., corresponding to the RCS_{TO}×RCS_{SC} term in equation (4)).

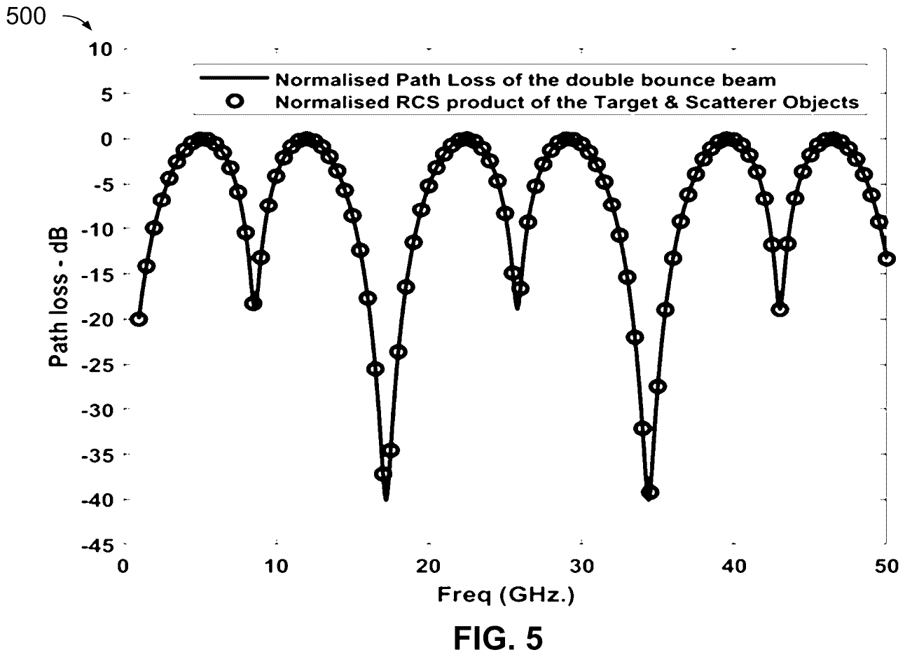

FIG. 5 is an illustrative chart 500 comparing normalized path loss of a DB RS to the RCS product (e.g., of TO RCS 410 and SC RCS 420) at different frequencies, according to one or more embodiments. For example, the WTRU determines a normalized path loss for a DB RS that is shaped by the term RCS_{TO}×RCS_{SC}. Further, for example, the WTRU determines a normalized path loss frequency profile of the DB RS including a similar pattern as the combined frequency profile of the TO and SC (e.g., of maxima and/or minima frequency locations, deep fading frequency locations, combinations of the same, or the like).

In accordance with certain representative embodiments of the present disclosure, relevant terminology is defined as follows.

A target may refer to an object being sensed by a WTRU by deriving characteristics of the object from a sensing signal. Targets, sensing targets, and TOs may be referred to interchangeably herein.

A SC may refer to an object in the environment that reflects an incident signal (e.g., RS) towards the WTRU. The SC object may reflect towards the WTRU a signal received from the TRP and/or a reflected signal from the TO. SCs and SC objects may be referred to interchangeably herein.

A target profile may refer to any information that describes characteristics of a target. Characteristics of a target described in a target profile may include at least one of: geometrical characteristics (e.g., size, dimension, shape, or the like); physical characteristics (e.g., material); electromagnetic characteristics (e.g., reflectivity, RCS, or the like); location; mobility (e.g., velocity); combinations of the same; or the like. The target profile may refer to a single value or multiple values that are evaluated across at least one of different time intervals, frequencies, angles, locations, combinations of the same, or the like (e.g., a probability distribution function). For example, the target RCS profile refers to the one or more target RCS patterns that are evaluated at different frequencies, angles, time intervals, or the like. In one example, the target RCS frequency profile refers to the target RCS pattern that is evaluated at different frequencies. In another example, the target RCS angular profile refers to the RCS pattern that is evaluated at different angles (e.g., AoAs, AoDs, incidence and/or scattering angle from the target, or the like). Target profiles and TO profiles may be referred to interchangeably herein.

A SC profile may refer to any information that describes characteristics of the SC object. Characteristics of a SC object described in an SC profile may include at least one of: geometrical characteristics (e.g., size, dimension, shape, or the like); physical characteristics (e.g., material); electromagnetic characteristics (e.g., reflectivity, RCS, or the like); location; mobility (e.g., velocity); combinations of the same; or the like. The SC profile may refer to a single value or multiple values that are evaluated across at least one of different time intervals, frequencies, angles, locations, combinations of the same, or the like (e.g., a probability distribution function). For example, the SC RCS profile refers to the one or more SC RCS patterns that are evaluated at different frequencies, angles, time intervals, or the like. In one example, the SC RCS frequency profile refers to the SC RCS pattern that is evaluated at different frequencies. In another example, the SC RCS angular profile refers to the RCS pattern that is evaluated at different angles (e.g., AoAs, AoDs, incidence and/or scattering angle from the SC, or the like). SC profiles and SC object profiles may be referred to interchangeably herein.

A RS profile may refer to the measured RS metric pattern (e.g., RSRPP, RSRP, RSCP, SINR, or the like) that is measured over different frequencies, time slots, angles, or the like.

SB reflection may refer to the reflection of an RS that is only reflected by a TO towards the WTRU. Herein, SB reflection and LoS reflection may be used interchangeably.

MB reflection may refer to the reflection of an RS that has been successively reflected by a TO and one or more SC objects towards the WTRU. DB reflection may refer to a subset of MB reflections that includes reflection of RSs that have been successively reflected by a TO and one SC object towards the WTRU. Herein, MB reflection and NLoS reflection may be used interchangeably.

A path (e.g., a resolvable path) may refer to an RS path associated with metrics that may be resolved and measured in the spatial domain and/or the temporal domain. In one example, the resolvable path corresponds to an RS path associated with metrics that may be resolved in the angular domain, e.g., associated with a specific measured AoA and/or AoA range. In another example, the resolvable path corresponds to an RS path associated with metrics that may be resolved in the temporal domain, e.g., associated with specific measured ToA and/or ToA range.

A SB reflection path length may refer to the total distance covered by a SB RS. A SB reflection path loss distance component may refer to a path loss component associated with the propagation of the SB RS through the single-bounce path length.

A sensing reference signal (Sen_RS) may refer to transmissions on the 3GPP radio interface that can be used for sensing purposes (e.g., a positioning reference signal (PRS)).

A RCS of an object (e.g., TO, SC) may refer to the ratio of reflected radio signal power in the direction of a WTRU (e.g., from the object) to the radio power density that is intercepted (e.g., by the object).

A MD signature of an object (e.g., TO, SC) may refer to the variation in the phase and/or the amplitude of the reflected radio signal from the object over a period of time due to object sub-motion (e.g., vibration, rotation, or the like).

A sensing parameter may refer to any parameters of a TO or a SC, including RCS, MD, or the like.

“Sensing measurement” may be used interchangeably with “measurement” or “sensing measurement event” herein.

In certain representative embodiments, TOs in the environment are in either LoS or NLoS view from the WTRU perspective. The WTRU may receive different types of reflections from the TO (e.g., SB, DB, MB, or the like). In ISAC, the ability to differentiate between SB and MB reflections from a TO is a goal. In one example, a single-bounce reflection from a TO is dependent only on the TO RCS, allowing the SB RS to be used in TO detection, tracking, or the like. In another example, DB and/or MB reflections from a TO are further dependent on the RCS of one or more SCs, requiring additional knowledge of the SC RCS (e.g., provided by a wireless network or a separate WTRU sensing stage) for TO detection, tracking, or the like.

In certain representative embodiments, the WTRU may receive (e.g., with positioning assistance information) a LOS and/or NLoS indication associated to a PRS ID for position applications. The LoS and/or NLoS indication may enable the WTRU to differentiate between LoS and NLoS PRS beams for accurate positioning. However, in sensing applications, the WTRU may not receive a LOS and/or NLoS indication associated to a type of RS reflection (e.g., SB, DB, MB, or the like).

Accordingly, systems and methods for the WTRU measuring, detecting, and reporting the type of reflection (e.g., SB/LoS, MB/NLoS) corresponding to a received signal are provided in the present disclosure. For example, the WTRU measures, detects, and reports the signal reflection type based on at least one of the following: measured RS metrics of the reflected RS from the TO and/or SCs; configured TO profile; one or more configured and/or measured SC profiles; combinations of the same; or the like.

In certain representative embodiments, the WTRU determines whether a received reference signal for sensing (e.g., Sen_RS) has been reflected only from a TO or whether the received reference signal for sensing has been additionally subjected to other reflections (e.g., from one or more SCs). For example, the determining of the reference signal for sensing is based on at least one of the following: measurements of certain metrics and corresponding configured thresholds; TO-related assistance information from the network (e.g., TO position, TO RCS, or the like); positioning assistance information; combinations of the same; or the like.

For example, a WTRU performs at least one of: receiving a configuration from a wireless network to perform sensing measurements related to a TO; receiving an RS for sensing and performing measurements of the reference signals; detecting SB (LoS) and/or MB (NLoS) events for each path of the reference signals; determine a degree and type of each SB/MB (LoS/NLoS) event; report the RS measurements and an indication of the SB/MB (LoS/NLoS) event to the wireless network; combinations of the same, or the like.

In some examples, the WTRU receives the configuration from the network, e.g., via RRC signaling, medium access control-control element (MAC-CE), or downlink control information (DCI) to perform sensing measurements related to a TO that may include at least one of: metrics and conditions to determine the RS association type, configurations for measurement framework including updates and termination, Sen_RS configuration, Sen_RS measurement and reporting configurations, measurement window in the time and/or spatial domain for the reflecting Sen_RS from the target and/or the SCs, sensing information received from the network, combinations of the same, or the like.

For example, metrics and conditions (e.g., thresholds) to determine the RS association type (e.g., single-bounce, double- and/or multi-bounce, TO, SC, or the like) are provided.

For example, the Sen_RS (e.g., PRS, or the like) configuration includes RS resource information (e.g., PRS beam IDs, periodicity, repetition factor, time gap, comb size, combinations of the same, or the like).

For example, the Sen_RS measurement and reporting configurations includes metrics to be measured (e.g., RSRP, RSRPP, RSCP, AoA, or the like) and/or thresholds for reporting update and termination.

For example, the sensing assistance information received from the network includes at least one of the following: positioning assistance information (e.g., PRS resource information including the beam IDs, AoDs, TRP coordinates, TRP orientation, WTRU orientation, or the like); TO sensing assistance information (e.g., TO location, average RCS, average RCS profile, MD profile, or the like); SC assistance information (e.g., SC object location, average RCS, average RCS profile, MD profile, or the like); combinations of the same; or the like.

In some examples, the WTRU receives the Sen_RS beams (e.g., PRS beams) and performs measurements based on the Sen_RS measurement configuration.

In some examples, the WTRU detects the SB (LOS) reflection event and/or the MB (NLoS) reflection event from the TO for each resolvable path of the received Sen_RS. For example, the detection of the SB (LoS) reflection event is based on at least one of determining a difference between the measured Sen_RS metric profile to the configured target profile to be below a configured threshold, determining a correlation between the measured Sen_RS metric profile to the configured target profile to be above a configured threshold, combinations of the same, or the like. Further, for example, the detection of the MB (NLoS) reflection event is based on at least one of determining a difference between the measured Sen_RS metric profile to the configured combined target-SC profile to be below a configured threshold, determining a correlation between the measured Sen_RS metric profile to the configured combined target-SC profile to be above a configured threshold, combinations of the same, or the like.

In some examples, the WTRU is triggered by the detection of the MB (NLoS) reflection event to determine the degree of MB (NLoS) target reflection (e.g., DB, TB, or the like) and the type of the MB (NLoS) RS path (e.g., the MB RS path is LoS or NLoS between the TRP and the TO and/or is LoS or NLoS between the TO and the WTRU).

In some examples, the WTRU reports to the wireless network, e.g., through the UL data or control channels (e.g., physical uplink shared channel (PUSCH), physical uplink control channel (PUCCH)), at least one of RS measurements, LOS and/or NLoS indications, combinations of the same, or the like.

For example, the RS measurements include at least one of the following: Sen_RS metric measurements (e.g., RSRP, RSRPP, RSCP, or the like) within the measurement window in time and/or spatial domains; measurement comparison results (e.g., difference, correlation, or the like) for each of the resolvable paths between the measured Sen_RS profile and the configured TO profile and/or configured combined TO-SC profile; combinations of the same; or the like.

For example, the LOS and/or NLoS indications include at least one of: Sen_RS IDs and/or the corresponding resolvable paths that are associated with SB and/or MB (LOS and/or NLoS) reflections from the TO; Sen_RS metric measurements (e.g., RSRP, RSRPP, RSCP, or the like) that are associated with SB and/or MB (LOS and/or NLoS) reflections from the target; degrees of the MB (NLoS) reflections (DB, TB, or the like); types of MB (NLoS) path, e.g., between the TRP and TO and/or the TO and WTRU (e.g., NLoS-LOS, LOS-NLoS, NLoS-NLoS, or the like); combinations of the same; or the like.

In certain representative embodiments, the SB (LOS) reflections from the TO are dependent on TO characteristics (e.g., type, size, material, mobility, or the like), while MB (NLoS) reflections from the TO are dependent on combined TO and SC characteristics. For example, the association between the RS measurements and the SB (LoS) and/or MB (NLoS) target reflection indication may assist the network in the RS configuration for TO sensing (e.g., RS beam management, frequency band selection, RS configuration, or the like). Further, for example, SB (LoS) reflection is used in estimating TO RCS, location, orientation, mobility information, or the like. Additionally, for example, MB (NLoS) reflection is used when the SB (LoS) reflections from the TO are not available or exposed to high noise levels or weak received signals. In this example, the MB (NLoS) paths may be used to extract information about TO mobility (e.g., velocity of TO motion or sub-motions) or TO RCS and/or location based on information regarding the SCs that are located in the proximity of the TO. Hence, the SB (LoS) and/or MB (NLoS) indications for target reflection may assist the wireless network in configuring the WTRU for the RS used in sensing of the TO.

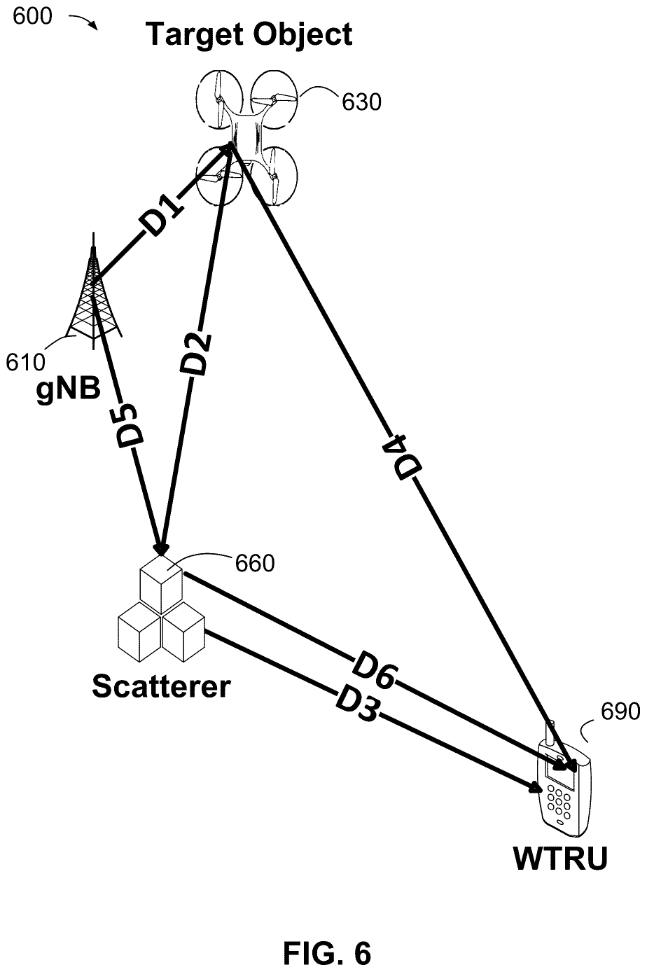

FIG. 6 is an exemplary diagram 600 of line of sight (LoS) and/or non-line of sight (NLoS) reflections associated with a TO 630 and/or SC 660, according to one or more embodiments. For example, in FIG. 6, D1=gNB−Target object distance, D2=Target object−Scatterer distance, D3=Scatterer−WTRU distance, D4=Target object−WTRU distance, D5=gNB−scatterer distance, and D6=Scatterer−WTRU distance. Also, for example, a SB/LoS reflection associated with a TO 630 includes the RS traveling along a path from a TRP 610 (e.g., a gNB) to a TO 630 (e.g., with the associated distance D1) and from the TO 630 to a WTRU 690 (e.g., with the associated distance D4). Further, for example, a MB/NLoS reflection associated with a TO 630 includes the RS traveling along at least one of: a path from the TRP 610 to the SC 660 (e.g., with the associated distance D5); a path from the TO 630 to the SC 660 and/or the SC 660 to the TO 630 (e.g., with the associated distance D2); a path from the SC 660 to the WTRU 690 (e.g., with the associated distance D3 (e.g., for SB) or D6 (e.g., for MB with the distance D5)); combinations of the same; or the like. In additionally, for example, a MB/NLoS reflection associated with a SC 660 includes the RS traveling along a path from a TRP 610 (e.g., a gNB) to the SC 660 (e.g., with the associated distance D5) and from the SC 660 to the WTRU 690 (e.g., with an associated distance D6).

In certain representative embodiments, the WTRU detects and/or reports SB and/or MB reflection from a TO and/or SCs as follows. For example, the detection and/or reporting includes at least one of a configuration, sensing assistance information, a measurement framework of the LOS and/or NLoS target reflections, a sensing measurement event, a sensing measurement event trigger, WTRU behaviors, WTRU reporting, a WTRU report update, WTRU report behavior, combinations of the same, or the like.

In certain representative embodiments, the WTRU receives a configuration for detecting and/or reporting SB and/or MB reflections including at least one of the following: WTRU capability information, target SB/MB reflection detection triggering conditions, measurement configuration for target SB/MB reflection detection, combinations of the same, or the like.

In some examples, the WTRU receives and decodes a first network request, e.g., received through RRC signaling, to acquire capability information. For example, the WTRU receives and decodes this first network request following a random-access procedure. Further, for example, the WTRU prepares a capability information message including information related to sensing capabilities (e.g., SC information, clutter identification information).

For example, the information contained in the WTRU capabilities message includes at least one of the following: sensing processing capabilities (e.g., inverse frequency transform capabilities, maximum number of samples, or the like); sensing frequency ranges; sensing bandwidth; sensing modes (e.g., monostatic, bistatic, or the like); sensing priorities; sensing spatial resolution; sensing time resolution; support of AoA determination and related angular resolution; sensing doppler resolution; reflectivity sensitivity (e.g., minimum power, SNR, absolute amplitude, or the like) for the reflections to be detectable by the WTRU; support of carrier phase measurements and related phase resolution; support of half-duplex or full-duplex for monostatic sensing, and related parameters (e.g., frequency range, maximum allowed transmit power for sensing, or the like); combinations of the same; or the like.

For example, the WTRU sends the WTRU capability information message through RRC signaling, e.g., over the physical uplink shared channel (PUSCH), to the wireless network. Further, for example, the WTRU capability information is used by the wireless network to optimize its configuration and resource allocation for sensing.

In some examples, the WTRU receives target SB/MB reflection detection triggering conditions. For example, the WTRU receives triggers for initiating the procedure to sense target SB and/or MB reflections using a target profile as part of the first configuration received from the wireless network. Further for example, the received triggers include time-based, event-based, location-based, mobility-based, and quality of service (QoS)-based triggers. Moreover, for example, the WTRU monitors for one or more target profiles and/or SC profiles. Additionally, for example, the WTRU is detects reflections for one or combined targets based on the received triggers or other predefined criteria.

In one example, the WTRU, based on the detection of the received triggers, sends a request to the wireless network to initiate the sensing target SB and/or MB reflections using profile measurement (e.g., RS profile, RCS profile, or the like). For example, the WTRU may initiate the sensing target SB and/or MB reflections through explicit initiation and/or implicit initiation. Further, for example, the WTRU explicitly initiates the reflections via uplink signaling, e.g., RRC signaling, MAC-CE, uplink control information (UCI), or reference signal transmissions (e.g., sounding reference signal (SRS) transmissions). Additionally, for example, the WTRU implicitly initiates the reflections through the selection of certain uplink resources, e.g., resources related to physical random access channel (PRACH), PUCCH, PUSCH, spatial relation info, or the like.

For example, the WTRU receives a first configuration from the network to initiate sensing target SB and/or MB reflections using profile measurements (e.g., RS profile, RCS profile, or the like) and reporting based on the details provided in the initial configuration.

The WTRU may request for other TO profiles and/or SC profiles (e.g., measured at a different angle, frequency band, or the like) from the wireless network if the sensing target and/or SC measurements are not satisfactory (e.g., below a certain sensing resolution, containing unmatched patterns). In one example, the WTRU receives another configuration from the network to assist the WTRU with the sensing target SB and/or MB reflection measurements. In this example, the another configuration may include additional or more granular information (e.g., in comparison with the first configuration) to assist the WTRU.

In some examples, the WTRU receives and decodes a first configuration from the network to provide measurement for target sensing, including performing and reporting SB and/or MB reflections from the sensing target. For example, the WTRU receives the configuration via RRC signaling, MAC-CE, or DCI.

For example, the WTRU receives a measurement event (e.g., target single-bounce and/or multi-bounce reflection detection measurements) configuration that may include at least one of the following parameters: a measurement event ID; an indication (e.g., a flag) to activate the target SB/MB reflection detection measurement procedure; reference signal information; metrics to be used for target reflection detection measurement; RS metric profiles to be measured for the target SB and/or MB reflection detection measurement; time window for the target reflection detection measurement procedure; thresholds for the target SB and/or MB reflection detection measurement procedure; triggers for initiating the target reflection detection measurement procedure, target SB and/or MB reflection detection measurement reporting information, combinations of the same, or the like.

For example, a measurement event ID includes at least one of the following: measurement event instance IDs (e.g., ID for target SB detection, ID for target MB detection, ID for target SB and/or MB reflection changes above a threshold, ID for target SB and/or MB reflection misdetection, or the like); RS IDs (e.g., PRS beam IDs); target IDs; SC IDs; combinations of the same; or the like.

For example, reference signal information includes at least one of the following: reference signal types (e.g., PRS); resource sets; time and/or frequency characteristics (e.g., pattern and density); cover codes; periodicity; power settings; beamforming and/or precoding related information (e.g., beam IDs, transmission configuration indicator (TCI) settings, quasi colocation (QCL) info, or the like); combinations of the same; or the like.

For example, metrics to be used for the target reflection detection measurement, e.g., in relation to reference signals, include at least one of the following: RSRP; RSRPP; RSCP; reference signal received quality (RSRQ); signal to interference plus noise ratio (SINR); channel quality indicator (CQI); rank indicator (RI); precoding matrix indicator (PMI); timing advance (TA); combinations of the same; or the like.

For example, RS metric profiles to be measured for the target SB and/or MB reflection detection measurement include at least one of the following: RS metric-frequency profile information (e.g., including relative received amplitude and/or phase at different frequencies and/or physical resource blocks (PRBs); RS metric-angular profile (e.g., including relative received power at one or more relative AoAs and/or AoDs); RS metric-time profile information (e.g., including relative received amplitude and/or phase at different time slots and/or PRBs); combinations of the same; or the like.

For example, the time window for the target reflection detection measurement procedure includes a start time, a minimum duration, and/or a maximum duration.

For example, thresholds for the target SB and/or MB reflection detection measurement procedure include at least one of the following: a static threshold to associate RS reflection to a SB and/or MB reflection from a sensing target; measurement accuracy thresholds; update thresholds; termination thresholds; a number of measurement occasions for update and termination; combinations of the same; or the like.

For example, triggers for initiating the target reflection detection measurement procedure include at least one of the following: time-based triggers, event-based triggers; location-based triggers; mobility-based triggers; QoS-based triggers; combinations of the same; or the like.

In one example, based on a time-based trigger, the WTRU initiates target SB and/or MB reflection detection measurements at predefined intervals for periodic monitoring.

In another example, based on an event-based trigger, the WTRU initiates target SB and/or MB reflection detection measurements when certain signal parameters (e.g., SINR) fall below configured thresholds.

In another example, based on a location-based trigger, the WTRU initiates target SB and/or MB reflection detection measurements when the WTRU enters and/or leaves certain geographical area and/or when it detects proximity to a particular target or location. In a further example, the WTRU is triggered to initiate target SB and/or MB reflection detection if the distance between the measured WTRU location (e.g., using radio access technology (RAT)-dependent and/or independent methods) and the configured target location is below a certain threshold.

In one example, based on a mobility-based trigger, the WTRU initiates target SB and/or MB reflection detection measurements when a WTRU is stationary or mobile. In a further example, the WTRU activates target SB and/or MB reflection detection if the measured WTRU velocity is above a threshold value and/or within a range of threshold values. Moreover, for example, the WTRU is triggered to activate target SB and/or MB reflection detection if the difference between the measured WTRU velocity and the configured target velocity is below a threshold value.

In another example, based on a QoS-based trigger, the WTRU initiates target SB and/or MB reflection detection measurements. For example, the initiating the target SB and/or MB reflection detection measurements is based on at least one of sensing accuracy or resolution, positioning-based QoS (e.g., positioning resolution in meters), reliability-based QoS (e.g., missed detection and false alarm percentages), combinations of the same, or the like.

In some examples, target SB and/or MB reflection detection measurement reporting information includes at least one of: a reporting type (e.g., periodic, semi-periodic, aperiodic, or the like); reporting thresholds (e.g., conditions for the WTRU to report target SB and/or MB reflection detection measurement information based on changes in the target reflection detection or other predefined criteria); reporting content and format (e.g., raw or processed data, statistical or instantaneous data, or the like); reporting resources, e.g., uplink resources such as transmission power, resource blocks, and scheduling information; error handling and resensing strategies; combinations of the same; or the like.

In certain embodiments, the WTRU receives sensing assistance information for detecting and/or reporting SB and/or MB. For example, the WTRU receives assistance information associated with the sensing target and/or the SC object from one or more TRPs. Further, for example, the WTRU receives the sensing assistance information semi-statically (e.g., via LTE positioning protocol (LPP) or RRC messages). Moreover, for example, the assistance information consists of at least one of the following: a sensing target and/or SC identified; association to the measurement event ID; sensing target/SC profile information; sensing TO and/or SC positioning information; sensing TO/SC mobility information; a validity time for sensing assistance information; combinations of the same, or the like.

In one example, a reflection identifier is based on a TO and/or SC location (e.g., TO and/or SC at (x1,y1,z1) with ID of 1, TO and/or SC at (x2,y2,z2) has with ID of 2). In another example, TO and/or SC identifiers are type-based (e.g., human targets have IDs starting with H, vehicle targets have IDs starting with V, or the like). In a further example, the TO and/or SC ID are associated to one or more TO and/or SC profiles (e.g., TO ID 1 has profile 1-RCS for RCS profile, and 1-loc for target 1 location profile, or the like)

In one example, the sensing TO ID and/or the SC object ID may be the same or part of the measurement event ID. In one example, the measurement event ID is part of the TO ID and/or the SC ID. In another example, a single target ID and/or SC ID is associated to one or more measurement event IDs. In a further example, multiple target IDs and/or multiple SC IDs may be associated to one or more measurement event IDs.

For example, sensing TO and/or SC profile information includes at least one of the following: RS metric-frequency profile information, e.g., including relative received amplitude (e.g., RSRP, RSRPP, SINR, or the like) and/or phase (e.g., RSCP) at different frequencies and/or PRBs; RS metric-angular profile, e.g., a including a relative received power for one or more relative AoAs and/or AoDs; RS metric-time profile information: e.g., a relative received amplitude and optionally phase at different time slots and/or PRB; RCS-frequency profile information: e.g., relative target RCS amplitude and/or phase at different frequencies and/or PRB; RCS-angular profile, e.g., including a relative target and/or SC RCS at a set of relative AoA and/or AoD; RCS—time profile information, e.g., relative TO and/or SC RCS amplitude and/or phase at different time slots and/or PRB; combinations of the same; or the like.

For example, sensing target and/or SC positioning information includes at least one of: absolute information (e.g., target coordinates (x, y, z)); relative information; coarse information (e.g., location received as an area between defined coordinates; cell ID; sector ID; combinations of the same; or the like. In one example, the WTRU receives TRP and/or WTRU positioning and/or orientation information to assist the WTRU to calculate the TO and/or SC location relative to the WTRU and/or TRP locations.

For example, sensing TO and/or SC mobility information includes at least one of: absolute information (e.g., TO and/or SC velocity, doppler frequency, or the like); relative information (e.g., with respect to the WTRU and/or TRP velocity); an uncertainty range (e.g., of velocity and/or doppler frequency); combinations of the same, or the like.

For example, validity time for sensing assistance information includes a total time duration when the sensing assistance information (e.g., provided by the wireless network) may be associated to the TO and/or SC. In one example, the validity time is configured in terms of a number of symbols, slots, frames, subframes, and/or seconds.

In certain embodiments, the WTRU performs measurements of the SB (LoS) and/or MB (NLoS) target reflections based on a framework described as follows.

In one example, the WTRU, after receiving RS configurations, target SB and/or MB reflection detection time window configurations, and/or sensing assistance information, receives the RS resources and an indication from the wireless network to initiate the target SB and/or MB reflection detection.

For example, the WTRU starts measuring the parameters (e.g., AoA, RSRP, RSRPP, ToA, or the like) for each RS ID that corresponds to each TRP in the measurement window. Further, for example, the measurements include at least one of the following: ToA measurement; AoA measurement; resolvable path determination; RS metric profile measurement (e.g., of resolvable paths); measurement of difference between two profiles; combinations of the same; or the like.

In one example, the WTRU is configured to measure the ToA and/or RS path delay (e.g., of a SB and/or MB reflection) based on at least one of the following: the timing of each RS path measured relative to the path timing used for determining RS time difference (RSTD) or WTRU receiver (Rx)—transmitter (Tx) time difference; the timing of each RS path measured relative to the ToA and/or path delay of the RS that is reflected from a reference target (e.g., tree, building, or the like); the timing of each RS path measured relative to the ToA and/or path delay of first path; the timing of each RS path measured relative to the ToA and/or path delay of a SB (LoS) path; combinations of the same; or the like.

In another example, the WTRU is configured to measure the AoA (e.g., the estimated azimuth angle (A-AoA) and vertical angle (Z-AoA)) of the received RS with respect to a reference direction. For example, the reference direction includes at least of the following: the global coordinate system (GCS); the local coordinate system (LCS) of the WTRU; a direction of the RS associate d with the SB (LoS) indication from the network; a direction of a configured RS (e.g., specific RS ID, first received RS, RS with highest SNR, or the like); combinations of the same or the like. Further, for example, the estimated A-AoA is measured relative to geographical North (e.g., positive in the counter-clockwise direction) and the estimated Z-AOA is measured relative to the zenith point (e.g., positive in the horizontal direction). Moreover, for example, the estimated A-AOA is measured relative to x-axis of the LCS (e.g., of the WTRU, positive in the counter-clockwise direction) and the estimated Z-AOA is measured relative to the z-axis of LCS (e.g., positive in the direction of the x-y plane).

In another example, the WTRU is configured to determine the resolvable path of the received RS in the temporal and/or spatial domain (e.g., RSs corresponding to different ToAs and/or AoAs). For example, the WTRU determines the resolvable path based on determining the peaks of the received RS metric (e.g., RSRP, RSRPP, RSCP, or the like) in the temporal and/or spatial domain. Further, for example, the WTRU is configured to determine the peaks of the received RS in the temporal and/or spatial domain based on at least one of the following: a maximum value of the RS metric values over the measurement window; a difference threshold value; a gradient or slope method; the difference between two consecutive RS peaks being above a configured threshold value; combinations of the same; or the like.

In one example, the WTRU determines a RS metric peak to be the measured RS metric that is greater than the previous and following measured RS metric, e.g., such that the difference between the current RS metric and the previous and/or following RS metric is greater than the difference threshold value.

In another example, the WTRU determines the RS metric peak based on the value of the RS metric gradient value over the measurement window. For example, the WTRU determines that the RS measurement n is a RS metric peak based on determining that the RS metric gradient value at n is zero or below a threshold minimum value, the RS metric gradient value at n−1 is a positive value, and the RS metric gradient value at n+1 is a negative value.

In one example, the WTRU is configured to determine the temporal resolvable paths of the received RS at specific spatial configuration (e.g., specific AoA, AoA range, orientation, or the like). In another example, the WTRU is configured to determine the spatial resolved paths of the received RS at specific temporal configuration (e.g., specific ToA, ToA range, or the like).

In one example, the WTRU associates the determined resolvable paths in the temporal and/or spatial domain to the corresponding measured ToA and/or AoA. In another example, the WTRU is configured to assign an ID to each resolvable path in the temporal and/or spatial domains.

In one example, the WTRU measures the RS metric (e.g., RSRP, RSRPP, RSCP, SINR, or the like) profile of the corresponding received RS resource for each resolvable path within a configured spatial and/or temporal measurement window. For example, the WTRU associates the RS metric profile of each resolved path to the corresponding measured RS metric.

For example, the WTRU measures the RS-metric frequency profile through the measurement of the RS metric value (e.g., magnitude, power, phase, or the like) at different frequencies (e.g., frequency PRBs, bandwidth parts (BWPs), bands, or the like). Further, for example, the WTRU measures the RS metric angular profile through the measurement of the RS metric value (e.g., magnitude, power, phase, or the like) at different angles that are associated with the RS resource (e.g., AoA, AoD, or the like). Additionally, for example, the WTRU measures the RS metric time profile, through the measurement of the RS metric value (e.g., magnitude, power, phase, or the like) at different time slots (e.g., time PRBs, symbols, frames, subframes, or the like).

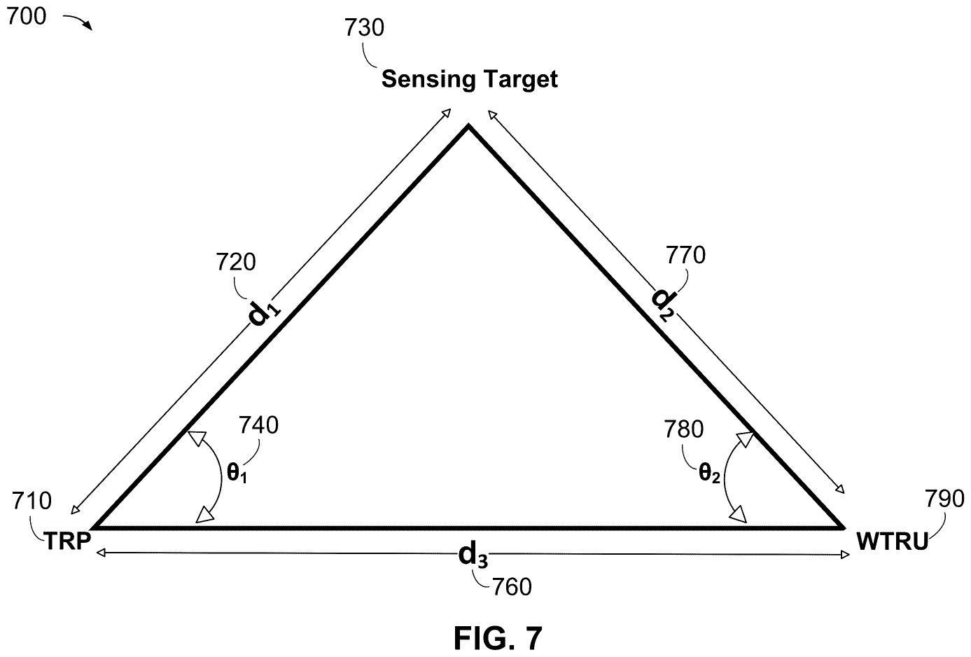

FIG. 7 is an illustrative diagram 700 of target location estimation using reflected RS measurements, according to one or more embodiments. In some examples, the WTRU is configured by the wireless network to determine the location of the sensing target 730 (e.g., and/or SC) via measurements. As shown in FIG. 7, in one example, the WTRU 790 measures an RS (e.g., sent by TRP 710) that is reflected from the sensing target 730 (e.g., and/or SC) to estimate the sensing target 730 (e.g., and/or SC) location that corresponds to this RS resource.

For example, the WTRU 790 may calculate the sensing target 730 position that corresponds to RS resource resolvable path that is reflected from the sensing target 730 based on calculating at least one of the following: a distance (e.g., d₃ 760) between the TRP 710 and WTRU 790; an angle (θ₁ 740) between the TRP 710-target 730 path and the TRP 710-WTRU 790 path (e.g., the LoS path); an overall path length d₄; a distance (d_{UE_S}) between the WTRU 790 and the target 730; coordinates of the sensing target 730 in the reference domain; combinations of the same; or the like.

For example, the WTRU calculates the distance (e.g., d₃ 760) between the TRP 710 and WTRU 790 based on known coordinates of the TRP 710 and WTRU 790. Further, for example, the WTRU calculates the angle (θ₁ 740) between the TRP 710-target 730 path and the TRP 710-WTRU 790 path (e.g., the LoS path) based on known AoDs of the RS resource, TRP coordinates, TRP orientation (e.g., rotation matrix), WTRU coordinates, and/or WTRU orientation. Additionally, for example, the WTRU calculates the overall (e.g., TRP 710-target 730-WTRU 790) path length d₄ based on measuring the ToF (e.g., based on WTRU Rx-Tx time difference) of the RS beam, e.g., in accordance with equation (6) as follows:

$${d}_{4} = {d}_{1} + {d}_{2} \qquad ( 6 )$$

where d₁ 720 and d₂ 770 correspond to the TRP 710-target 730 path length and target 730-WTRU 790 path length, respectively. Also, for example, the WTRU calculates the angle (θ₂ 780) between the target 730-WTRU 790 path and the TRP 710-WTRU 790 path using similar methods to those described regarding the angle (θ₁ 740). Moreover, for example, the WTRU calculates the distance between itself and the target d_{UE_S} in accordance with equation (7) as follows:

$${d}_{UE\_S} = \frac{{{d}_{3}}^{2} + {{d}_{4}}^{2} - 2 {d}_{3} {d}_{4} cos ( {θ}_{1} )}{2 {d}_{4} - 2 {d}_{3} cos ( {θ}_{1} )} \qquad ( 7 )$$

In one example, the WTRU calculates the coordinates of the sensing target 730 in the reference domain using the coordinates of the TRP 710, the distance between the TRP 710 and the sensing target 730 (e.g., d₁ 720) and the TRP 710 orientation (e.g., rotation matrix).

In another example, the WTRU 790 measures the RCS that is associated with the received RS resource resolvable path. For example, the WTRU 790 measures the RCS of the sensing target 730 (e.g., and/or SC) based on the sensing target 730 (e.g., and/or the SC) location and performing at least one of the following: calculating the channel gains H (d₁) and H (d₂) based on the corresponding distances d₁ 720 and d₂ 770, respectively; measuring the channel gain of the received RS resource H, through the measurement of RS metrics (e.g., RSRP, RSRPP, RSCP, channel impulse response (CIR), or the like); measuring the RCS of the sensing target 730 and/or the SC corresponding to the received RS resource; combinations of the same; or the like.

In one example, the WTRU 790 measures the RCS of the sensing target 730 and/or the SC corresponding to the received RS resource in accordance with equation (8) as follows:

$$RCS = \frac{H}{H ( {d}_{1} ) \times H ( {d}_{2} )} \qquad ( 8 )$$

In another example, the WTRU 790 measures the RCS profile of a sensing target 730 and/or the SC that corresponds to the received RS resources resolvable paths. For example, the WTRU 790 measures the RCS frequency profile through the measurement of the RCS value (e.g., magnitude, phase, or the like) at different frequencies (e.g., frequency PRBs, BWPs, bands, or the like). Further, for example, the WTRU 790 measures the RCS angular profile through the measurement of the RCS value (e.g., magnitude, phase, or the like) at resolvable paths of the same RS resource (e.g., AoA, AoD, or the like). Additionally, for example, the WTRU 790 measures the RCS time profile through the measurement of the RCS value (e.g., magnitude, phase, or the like) at different time slots (e.g., time PRBs, symbols, frames, subframes, or the like).

In some examples, the WTRU is configured to determine the difference between two profiles, which is described as follows.

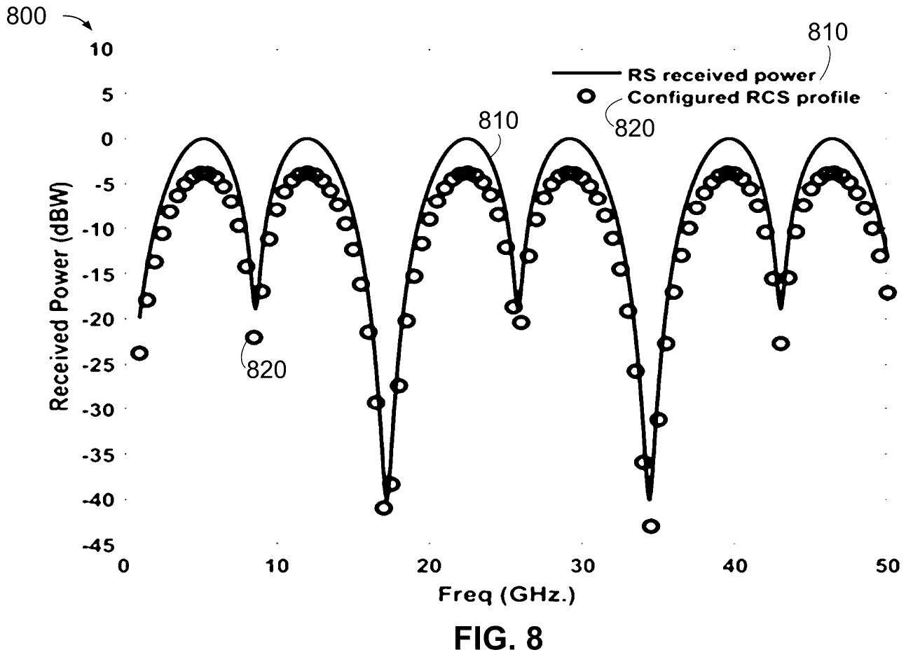

FIG. 8 is an illustrative chart 800 of measured RS received power 810 and a configured RCS profile 820 (e.g., in dBW) at different frequencies (e.g., in GHz), according to one or more embodiments. As shown in FIG. 8, in one example, the WTRU is configured to determine the difference between a measured RS-metric resolvable path profile 810 (e.g., of RSRPP, RSCP, SINR, or the like) and a configured profile 820 (e.g., a TO and/or SC RCS profile, a TO and/or SC micro-Doppler profile, a combined TO-SC RCS profile, or the like). For example, the WTRU may measure the difference between two profiles in accordance with equation (9) as follows:

$$D = {\sum }_{i = 1}^{M} ( {x}_{i} - {y}_{i} ) \qquad ( 9 )$$

where xᵢ represents the measured value of the RS metric 810 at the i-th point (e.g., frequency, time, angle, or the like) and y; represents the configured profile value 820 at the i-th point. Further, for example, D represents the sum of the difference between the measured and configured values of the TO, SC, and/or combined (e.g., TO-SC) profile.

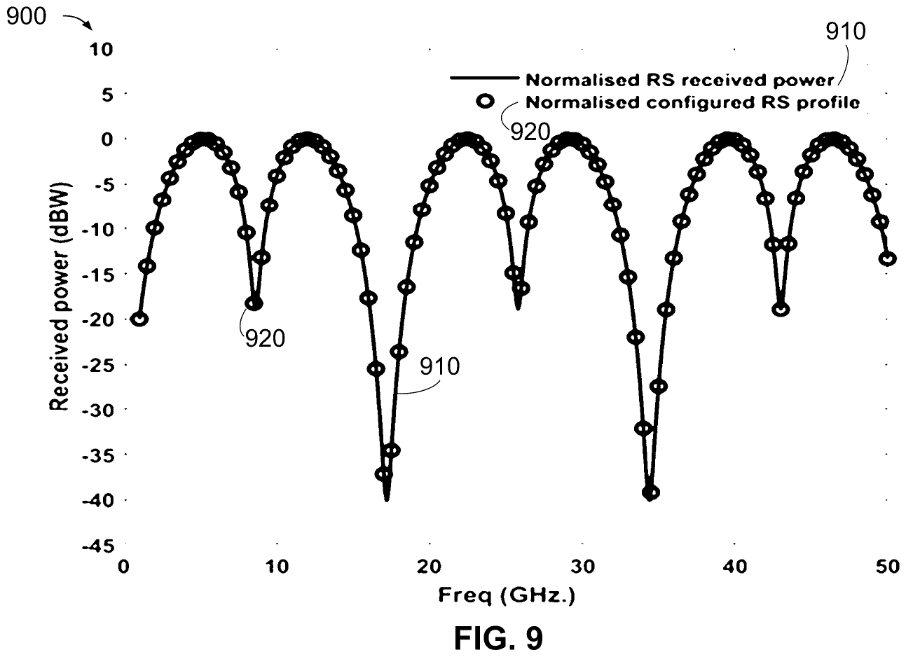

FIG. 9 is an illustrative chart 900 of normalized measured RS received power 910 and a normalized configured RCS profile 920 at different frequencies, according to one or more embodiments. As shown in FIG. 9, in one example, the WTRU measures the difference between the normalized measured RS metric profile 910 and the normalized configured TO, SC, and/or combined (e.g., TO-SC) profile 920 in accordance with equation (10) as follows:

$${D}_{N} = {\sum }_{i = 1}^{M} ( {x}_{N , i} - {y}_{N , i} ) \qquad ( 10 )$$

where x_{N,i} represents the normalized measured value of the RS metric 910 at the i-th point (e.g., frequency, time, angle, or the like) and y_{N,i} represents the normalized configured profile value 920 at the i-th point. Further, for example, D_{N} represents the sum of the difference between the measured and configured values of the TO, SC, and/or combined (e.g., TO-SC) profile.

In another example, the WTRU measures the correlation between the measured RS metric profile 810 and the configured TO, SC, and/or combined (e.g., TO-SC) profile 820 in accordance with equation (11) as follows:

$$C = \frac{{\sum }_{i = 1}^{M} ( {x}_{i} - \overline{x} ) ( {y}_{i} - \overline{y} )}{{\sum }_{i = 1}^{M} {( {x}_{i} - \overline{x} )}^{2} {( {y}_{i} - \overline{y} )}^{2}} \qquad ( 11 )$$

where x̅ is the average value of the measured RS metric profile 810 over M sampling points (e.g., time, frequency, angle, or the like), y̅ is the average value of the configured TO, SC and/or combined (e.g., TO-SC) profile. For example, C represents the correlation coefficient between the two profiles. Further, for example, the WTRU measures the correlation between the normalized RS metric profile 910 and the normalized configured TO, SC, and/or combined (e.g., TO-SC) profile 920.

In certain representative embodiments, the WTRU detects a sensing measurement event. For example, the sensing measurement event is defined as a SB/LoS target reflection event, a MB/NLoS target reflection event, or the like.

For example, a detected SB/LoS target reflection event indicates matching between the measured RS metric profile of the resolvable path and the configured TO profile. Further, for example, the detected SB/LOS event indicates a mismatch between the measured RS metric of the resolvable path and the configured and/or measured profiles of one or more SCs. Additionally, for example, the detected SB/LoS event corresponds to a measured RS resolvable path that is single-bounced by the TO and/or reflected directly from the TO. Moreover, the detected SB/LOS event indicates that the target is in LoS position with the TRP and the WTRU.

For example, a detected MB/NLoS target reflection event indicates a correlation between the measured RS metric profile of the resolvable path and the configured target profile is within a threshold range and/or a difference between the measured RS metric profile of the resolvable path and the configured target profile is above a threshold range. Further, for example, the detected MB/NLoS event indicates a correlation between the measured RS metric of the resolvable path and measured profiles of one or more of the SCs is above a configured threshold. Additionally, for example, the detected MB/NLoS event indicates a correlation and/or matching between the measured RS metric of the resolvable path and the combined profile of the target and one or more SCs. Moreover, for example, the detected MB/NLoS event indicates that the measured RS resolvable path is multi-bounced by the target and one or more SCs. Also, for example, the detected MB/NLoS event indicates that the target is in a NLoS position with the TRP and/or the WTRU.

In some examples, the WTRU is configured to determine the degree of the MB/NLoS target reflection event. For example, the WTRU may determine N-bounce reflection, corresponding to the number of bounces N of a MB reflection. Further, for example, a determined N-bounce reflection event indicates matching between the measured RS metric profile of the resolvable path and the combined configured profile of the target and N SCs. Additionally, for example, a determined N-bounce reflection event indicates that the measured RS resolvable path is N-bounced by the target and one or more SCs. Moreover, for example, the WTRU determines an N-bounce reflection event where N=2, indicating DB target reflection. Also, for example, the WTRU determines an N-bounce reflection event where N=3, indicating TB target reflection.

In some examples, the WTRU is configured to determine the type of the multi-bounce target reflection event to be at least one of NLoS-LOS reflection, LoS-NLoS reflection, NLoS-NLoS reflection, combinations of the same, or the like.

For example, a determined NLoS-LOS reflection event indicates that a difference between the measured AoA (e.g., absolute, relative, or the like) of the determined MB/NLoS RS resolvable path and the configured target AoA is below a configured threshold. Further, for example, the determined NLoS-LOS reflection event indicates that a difference between the configured AoD of the determined MB/NLoS RS resolvable path and the configured target AoD is above a configured threshold. Additionally, for example, the determined NLoS-LOS reflection event indicates that the TO is in a NLoS position with respect to the TRP and in a LoS position with respect to the WTRU, e.g., based on a measured RS metric and/or metric profile of the resolvable path.

For example, a determined LoS-NLoS reflection event indicates that a difference between the measured AoA (e.g., absolute, relative, or the like) of the determined MB/NLoS RS resolvable path and the configured target AoA is above a configured threshold. Further, for example, the determined LoS-NLoS reflection event indicates that a difference between the configured AoD of the determined MB/NLoS RS resolvable path and the configured target AoD is below a configured threshold. Additionally, for example, the determined LoS-NLoS reflection event indicates that the TO is in LoS position with respect to the TRP and in NLoS position with respect to the WTRU, e.g., based on a measured RS metric and/or metric profile of the resolvable path.

For example, a determined NLoS-NLoS reflection event indicates that a difference between the measured AoA (e.g., absolute, relative, or the like) of the determined MB/NLoS RS resolvable path and the configured target AoA is above a configured threshold. Further, for example, the determined NLoS-NLoS reflection event indicates that a difference between the configured AoD of the determined MB/NLoS RS resolvable path and the configured target AoD is above a configured threshold. Additionally, for example, the determined NLoS-NLoS reflection event indicates that the TO is in NLoS position with respect to the TRP and in NLoS position with respect to the WTRU, e.g., based on a measured RS metric and/or metric profile of the resolvable path.

In certain representative embodiments, the WTRU determines a sensing measurement event to be SB/LoS target reflection event, a MB/NLoS target reflection event, or the like based on one or more sensing measurement event triggers. The one or more sensing measurement event triggers may include SB/LoS target reflection event triggers and/or MB/NLoS target reflection event triggers.

For example, the WTRU determines SB/LOS target reflection events for a resolvable path of the measured RS based on at least one of the following SB/LOS target reflection event triggers: a measured RS-metric (e.g., RSRPP, RSCP, SINR, CIR, or the like) is above a preconfigured threshold and/or within a configured threshold range; a difference between the measured RS-metric (e.g., RSRPP, RSCP, SINR, CIR, or the like) of the resolvable path and corresponding configured target RS-metric is below a configured threshold; a correlation between the measured RS-metric (e.g., RSRPP, RSCP, SINR, CIR, or the like) of the resolvable path and corresponding configured target RS-metric is above a preconfigured threshold; a difference between the measured and configured target position is below a preconfigured threshold; a difference between the measured and configured target RS-metric (e.g., RSRPP, RSCP, SINR, CIR, or the like) profile is below a preconfigured threshold; a difference between the measured and configured target profile (e.g., RCS profile) is below a preconfigured threshold; a difference between the measured and configured target doppler is below a preconfigured threshold; a difference between the measured AoA and/or ToA of the resolvable path and the configured target AoA and/or ToA is below a preconfigured threshold; combinations of the same; or the like.

For example, the WTRU determines MB/NLoS target reflection events for a resolvable path of the measured RS based on at least one of the following MB/NLoS target reflection event triggers: a measured RS-metric (e.g., RSRPP, RSCP, SINR, CIR, or the like) is above a preconfigured threshold and/or within a configured threshold range; a difference between a measured RS-metric (e.g., RSRPP, RSCP, SINR, CIR, or the like) and/or RS-metric profile of the resolvable path and corresponding configured target RS-metric and/or target RS-metric profile is within a configured threshold range; a difference between a measured RS-metric (e.g., RSRPP, RSCP, SINR, CIR, or the like) and/or RS-metric profile of the resolvable path and corresponding configured and/or measured SC RS-metric and/or SC RS-metric profile is within a configured threshold range; a difference between a measured RS-metric (e.g., RSRPP, RSCP, SINR, CIR, or the like) and/or RS-metric profile of the resolvable path and corresponding configured and/or measured combined target and/or SC RS-metric and/or RS-metric profile is below a configured threshold; a correlation between a measured RS-metric (e.g., RSRPP, RSCP, SINR, CIR, or the like) and/or RS-metric profile of the resolvable path and corresponding configured and/or measured combined target and/or SC RS-metric and/or RS-metric profile is above a configured threshold; a difference between the measured and configured target position is above a configured threshold; a difference between the measured and configured target profile (e.g., RCS profile) is within a configured threshold range; a difference between the measured and configured SC profile (e.g., RCS profile) is within a configured threshold range; a difference between the measured and configured combined target and/or SC profile (e.g., RCS profile) is below a configured threshold; a difference between the measured AoA and/or ToA of the resolvable path and the configured SC AoA and/or ToA is below a configured threshold; combinations of the same; or the like.

In one example, the WTRU is configured to associate the determined event (e.g., SB/LOS target reflection event, MB/NLoS target reflection event, or the like) to the resolvable path ID of the measured RS. In another example, the WTRU is configured to report the resolvable paths of the measured RS resource(s) and the associated indication of SB and/or MB reflection from the TO. In a further example, the WTRU is configured to report the target ID and the associated resolvable paths, e.g., such that each resolvable path is associated with SB and/or MB reflection from the TO.

In certain representative embodiments, in connection with the detection of SB and/or MB reflection from a TO, the WTRU performs at least one of the following behaviors: determining MB target reflection degree; determining MB target reflection type; determining SB/MB association; measuring SB/MB target reflection detection uncertainty; combinations of the same; or the like.

In some examples, the WTRU is configured to determine the degree of the MB RS reflection from the TO. For example, the WTRU determines a N-bounce reflection event, where N is the number of bounces and/or reflections from the target, based on at least one of the following: a difference between the measured RS-metric (e.g., RSRPP, RSCP, SINR, CIR, or the like) and/or RS-metric profile of the resolvable path and corresponding configured and/or measured combined TO-SC (e.g., TO and (N−1) SCs) RS-metric and/or RS-metric profile is below a configured threshold; a difference between the measured and configured combined TO-SC (e.g., TO and (N−1) SCs) profile (e.g., RCS profile, doppler profile, micro-doppler profile, or the like) is below a configured threshold; a difference between the measured ToA of the RS resolvable path and the configured ToA of the NLoS path that includes the target and (N−1) SCs (e.g., based on the configured positions for the target and the (N−1) SCs) is below a configured threshold; a difference between the measured AoA of the RS resolvable path and the configured AoA of the target or at least one of the (N−1) SCs is less than a configured threshold; a difference between the configured AoD of the measured RS and configured AoD of the target or at least one of the (N−1) SCs (e.g., based on the configured target and/or SC location and configured TRP orientation) is less than a configured threshold; combinations of the same; or the like.

In some examples, the WTRU is configured to determine the type of the MB/NLoS resolvable path of the measured RS (e.g., the NLoS resolvable path (TRP-TO, TO-WTRU) may correspond to (NLoS, LoS), (LOS, NLoS), (NLoS, NLoS)).

For example, the WTRU determines NLoS target reflection detection between the TRP and the target based on at least one of the following: a difference between the configured AoD of the measured RS and configured AoD of the at least one of (e.g., all) the configured and/or measured SCs (e.g., based on the configured and/or measured SC location and configured TRP orientation) is below a configured threshold; a difference between the configured AoD of the measured RS and configured AoD of the target (e.g., based on the configured and/or measured target location and configured TRP orientation) is above a configured threshold; a difference between the measured ToA (e.g., and/or RSRPP) of the RS resolvable path and the configured and/or measured ToA (e.g., and/or RSRPP) for the NLoS path between the TRP and the target is below a configured threshold; a difference between the measured ToA (e.g., and/or RSRPP) of the RS resolvable path and the configured and/or measured ToA (e.g., and/or RSRPP) for the LoS path between the TRP and the target is above a configured threshold; combinations of the same; or the like.

For example, the WTRU determines LoS target reflection detection between the TRP and the target based on at least one of the following: a difference between the configured AoD of the measured RS and configured AoD of the at least one of (e.g., all) the configured and/or measured SCs (e.g., based on the configured and/or measured SC location and configured TRP orientation) is above a configured threshold; a difference between the configured AoD of the measured RS and configured AoD of the target (e.g., based on the configured and/or measured target location and configured TRP orientation) is below a configured threshold; a difference between the measured ToA (e.g., and/or RSRPP) of the RS resolvable path and the configured and/or measured ToA (e.g., and/or RSRPP) for the NLoS path between the TRP and the target is above a configured threshold; a difference between the measured ToA (e.g., and/or RSRPP) of the RS resolvable path and the configured and/or measured ToA (e.g., and/or RSRPP) for the LoS path between the TRP and the target is below a configured threshold; combinations of the same; or the like.

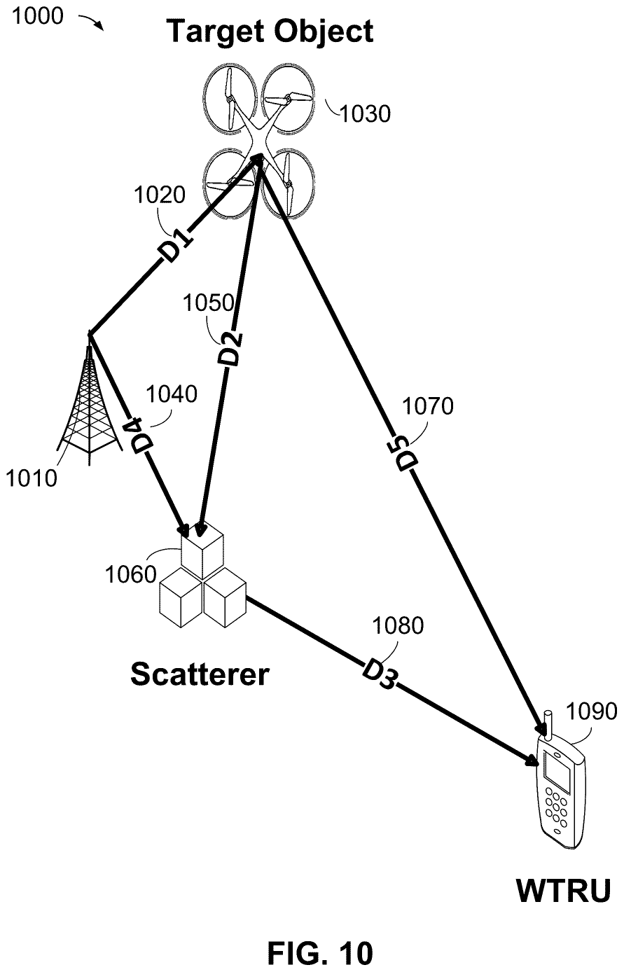

FIG. 10 is an exemplary diagram 1000 of target DB RS reflection, according to one or more embodiments. For example, in FIG. 10, D1=gNB−Target object distance, D2=Target object−Scatterer distance, D3=Scatterer−WTRU distance, D4=gNB−scatterer distance, and D5=Target object−WTRU distance. As shown in FIG. 10, for example, the WTRU 1090 determines a difference in measured ToA between a first scenario where the TRP 1010-TO 1030 path is NLoS and a second scenario where the TRP 1010-TO 1030 path is LoS. Further, for example, the measured ToA of the RS resolvable path is dependent on the total covered distance by the RS, which is determined by the WTRU as follows.

For example, in the first scenario where the TRP 1010-TO 1030 path is NLoS, the WTRU 1090 determines a total covered distance DT1 based on the number of successive reflections (m) between the TO 1030 and SC 1060. In one example, the WTRU 1090 determines an even number of reflections between the TO 1030 and SC 1060 (e.g., m is even) and determines the total covered distance DT1 in accordance with equation (12) as follows:

$$DT 1 = D 4 + m D 2 + D 3 \qquad ( 12 )$$

where D4 1040 represents the distance of the TRP 1010-SC 1060 path, D2 1050 represents the distance of the SC 1060-TO 1030 path, and D3 1080 represents the distance of the SC 1060-WTRU 1090 path. In another example, the WTRU 1090 determines an odd number of reflections between the TO 1030 and SC 1060 (e.g., m is odd) and determines the total covered distance DT1 in accordance with equation (13) as follows:

$$DT 1 = D 4 + m D 2 + D 5 \qquad ( 13 )$$

where D5 1070 represents the distance of the TO 1030-WTRU 1090 path.

For example, in the second scenario where the TRP 1010-TO 1030 path is LoS, the WTRU 1090 determines a total covered distance DT1 based on the number of successive reflection (m) between the TO 1030 and SC 1060. In one example, the WTRU 1090 determines an even number of reflections between the TO 1030 and SC 1060 (e.g., m is even) and determines the total covered distance DT2 in accordance with equation (14) as follows:

$$DT 1 = D 1 + m D 2 + D 5 \qquad ( 14 )$$

where D1 1020 represents the distance of the TRP 1010-TO 1030 path. In another example, the WTRU 1090 determines an odd number of reflections between the TO 1030 and SC 1060 (e.g., m is odd) and determines the total covered distance DT1 in accordance with equation (15) as follows:

$$DT 1 = D 1 + m D 2 + D 3 \qquad ( 15 )$$

For example, the WTRU determines NLoS target reflection detection between the TO and the WTRU based on at least one of the following: a difference between the measured AoA of the measured RS resolvable path and configured AoA of at least one of (e.g., all) the configured and/or measured SCs (e.g., based on the configured and/or measured SC location and/or configured WTRU orientation) is below a configured threshold; a difference between the measured AoA of the measured RS resolvable path and configured AoA of the target (e.g., based on the configured and/or measured target location and/or configured WTRU orientation) is above a configured threshold; a difference between the measured ToA (e.g., and/or RSRPP) of the RS resolvable path and the configured and/or measured ToA (e.g., and/or RSRPP) for the NLoS path between the WTRU and the target is below a configured threshold; a difference between the measured ToA (e.g., and/or RSRPP) of the RS resolvable path and the configured and/or measured ToA (e.g., and/or RSRPP) for the LoS path between the WTRU and the target is above a configured threshold; combinations of the same; or the like.

For example, the WTRU determines LoS target reflection detection between the TO and the WTRU based on at least one of the following: a difference between the measured AoA of the measured RS resolvable path and configured AoA of at least one of (e.g., all) the configured and/or measured SCs (e.g., based on the configured and/or measured SC location and/or configured WTRU orientation) is above a configured threshold; a difference between the measured AoA of the measured RS resolvable path and configured AoA of the target (e.g., based on the configured and/or measured target location and/or configured WTRU orientation) is below a configured threshold; a difference between the measured ToA (e.g., and/or RSRPP) of the RS resolvable path and the configured and/or measured ToA (e.g., and/or RSRPP) for the NLoS path between the WTRU and the target is above a configured threshold; a difference between the measured ToA (e.g., and/or RSRPP) of the RS resolvable path and the configured and/or measured ToA (e.g., and/or RSRPP) for the LoS path between the WTRU and the target is below a configured threshold; combinations of the same; or the like.

In some examples, the WTRU determines a SB and/or MB association of the reflected RS resource resolvable path from the target as hard values (e.g., LoS-associated, NLoS-associated, not associated, or the like) or soft values (e.g., 0, 1, or the like) based on the SB and/or MB target reflection detection uncertainty range. In one example, SB and/or MB association is expressed in the form of integer numbers, where the value of the integer indicates the type and degree of the RS bounce (e.g., 0 indicates not associated, 1 indicates single-bounce, 2 indicates double-bounce, or the like). In another example, the WTRU associates the type of a MB RS resolvable path in pair set form, e.g., {“x”, “y”}, where “x” indicates the type of TRP-TO path and “y” indicates the type of TO-WTRU path. Further, for example, the pair set form takes definite values (e.g., LoS, NLoS). Additionally, for example, the pair set takes integer values, where the values indicate the type and degree of the RS bounce (e.g., 1 indicates SB, 2 indicates DB, or the like).

In some examples, the WTRU is configured to measure and report an uncertainty range associated with the SB and/or MB target reflection detection. For example, the uncertainty range is calculated based on at least one of the following: an uncertainty range in AoA of the RS (e.g., DL-RS) resolvable path; an uncertainty range in the ToA of the RS (e.g., DL-RS) resolvable path; an uncertainty range in an RS-metric (e.g., RSRP, RSRPP, RSRQ, RSCP, SINR, combinations of the same, or the like); an uncertainty in TO and/or SC location; an uncertainty in TO and/or SC mobility information; an uncertainty in WTRU position; an uncertainty in TO and/or SC profile information; combinations of the same; or the like.

For example, the WTRU calculates the uncertainty range in AoA of the RS (e.g., DL-RS) resolvable path based on receiving the RS resource resolvable path at an AoA which is less than the minimum AoA resolution ΔAoAₘᵢₙ that can be detected by the WTRU. Further, for example, the WTRU receives the RS resource resolvable path at an AoA equal to 0 and measures the received RS resolvable path AoA as θ₁ such that |θ−θ₁|<ΔAoAₘᵢₙ. Additionally, for example, the WTRU calculates the uncertainty in the target reflection detection based on the difference between the measured AoA and the actual AoA.

For example, the WTRU calculates the uncertainty range in the ToA of the RS (e.g., DL-RS) resolvable path based on the difference between the calculated ToA of the RS resource resolvable path and the actual ToA of the RS resource being less the minimum ToA resolution ΔToA that can be detected by the WTRU. Further, for example, the WTRU calculates an uncertainty range equal to the difference between the measured and calculated ToA. Additionally for example, the WTRU determines uncertainty in the calculated distance between the WTRU, TO, and/or TRP based on the uncertainty in the ToA.

For example, the WTRU calculates the uncertainty range in an RS-metric (e.g., RSRP, RSRPP, RSRQ, RSCP, SINR, combinations of the same, or the like). In one example, the WTRU calculates a received power of a RS (e.g., DL-RS) resolvable path based on the channel gain over this path and/or the level of noise and/or the resolution of the WTRU for the minimum detected power. Further, for example, the WTRU determines an uncertainty in the RS profile measurement for the resolvable path and/or the uncertainty in the comparison with the configure TO and/or SC profile based on the uncertainty range of the corresponding RS-metric (e.g., RSRP, RSRPP, RSRQ, RSCP, SINR, combinations of the same, or the like).

For example, the WTRU determines uncertainty in TO and/or SC locations based on false estimation of TO and/or SC locations.

For example, the WTRU determines the uncertainty in WTRU position based on RAT-dependent or independent methods. Further, for example, the WTRU determines uncertainty in WTRU position based on WTRU mobility in the time gap between target reflection detection initiation and target reflection detection calculation.

For example, the WTRU determines uncertainty in TO and/or SC profile information based on the measurement time window for TO and/or SC reflection detection exceeding the validity time of the configured sensing target profile by a specific threshold.

In one example, the WTRU represents the uncertainty range of the SB and/or MB target reflection detection in the form of a probability function (e.g., an RS resource resolvable path ID X is LoS and/or NLoS reflected from target ID Y with a probability of Z). In another example, the WTRU expresses the uncertainty range of the SB and/or MB target reflection detection in the form of individual and/or combined uncertainty ranges of the measured RS-metric (e.g., RSRP, RSRPP, RSRQ, RSCP, SINR, combinations of the same, or the like) or RS-metric profiles and the measured TO and/or SC profile.

In one example, the WTRU determines that the received reflected RS resource is not associated with a specific target based on the uncertainty range exceeding a maximum preconfigured threshold.

In certain embodiments, the WTRU reports information related to the detection of SB and/or MB target reflection to the wireless network. For example, the WTRU performs SB and/or MB target reflection detection measurements and sends a SB and/or MB target reflection detection measurement report (e.g., in aperiodic, periodic or semi-persistent form) over an uplink control or data channel. Further, for example, the SB and/or MB target reflection detection measurement report contains at least one of the following: measurements of the RS that is reflected from the sensing target, resolvable path measurements that are associated with each RS resource, SB and/or MB association information, TO ID(s), SC ID(s), uncertainty ranges associated with reflections, uncertainty ranges of the measurements, combinations of the same, or the like.

For example, measurements of the RS that is reflected from the sensing target include at least one of the following: RS metric measurements (e.g., RSRP, RSRPP, RSRQ, RSCP, SINR, combinations of the same, or the like); RS metric profile measurements; resolvable path determination measurements (e.g., peak determination, relative and/or absolute ToA measurements, relative and/or absolute AoA measurements); combinations of the same; or the like.

For example, resolvable path measurements that are associated with each RS resource include at least one of the following: a resolvable path ID; an associated RS ID; measured AoA and/or ToA of the resolvable path and the corresponding uncertainty ranges; measured TO profile, SC profile, and/or combined profile (e.g., location profile, RCS profile, doppler profile, micro-doppler profile, or the like); SB and/or MB target reflection detection event measurements (e.g., comparison measurements between the measured resolvable path RS metric profile and the configured TO and/or SC profile); N-bounce target reflection detection event measurements; measurements related to the determination of the MB target reflection with respect to the TRP-TO and/or TO-WTRU paths; combinations of the same; or the like.

For example, SB and/or MB association information includes at least one of the following: RS ID(s) and their corresponding resolvable path ID(s) associated to SB and/or MB target reflection;
a degree of the MB indication (e.g., DB, TB, N-bounce, or the like); a type of MB target reflection detection with respect to the TRP-TO and/or TO-WTRU paths (e.g., (NLoS, LoS), (LOS, NLoS), (NLoS, NLoS)); a method used for SB and/or MB target reflection detection, MB degree determination, and/or MB type determination (e.g., comparison against the target profile, artificial intelligence (AI), machine learning (ML) model, combinations of the same, or the like); association criteria of the SB and/or MB target reflection status to each RS resolvable path (e.g., soft, hard, probability function, or the like); measurement values associated to the detected reflections; combinations of the same; or the like. Further, for example, the measurement values associated to the detected reflections include at least one of the following: a difference between the measured profile and the configured TO and/or SC and/or combined profile; a correlation between the measured profile and the configured TO and/or SC and/or combined profile; a difference between the measured TO and/or SC location and the configured target and/or SC location; combinations of the same, or the like.

For example, the SC ID(s) include at least one of the following: SC ID(s) associated with each RS resource that is reflected from the target; SC ID(s) associated with each RS resource resolvable path that is reflected from the target; a number of SCs associated with each RS resource and/or RS resource resolvable path reflected from the target; combinations of the same; or the like.

For example, the uncertainty range is associated with at least one of the following: SB and/or MB target reflection detection; a degree of the MB target reflection (e.g., double, triple, or the like); a type of the MB target reflection; combinations of the same, or the like.

For example, the uncertainty ranges of the measurements are specified as a variance of the obtained reference signal metrics (e.g., RSRP, RSRPP, absolute or relative phase, instantaneous frequency shifts, or the like).

In certain representative embodiments, the WTRU reports updates in connection with the detection of SB and/or MB target reflection to the wireless network as follows.

For example, the WTRU determines SB and/or MB target reflection detection and an associated uncertainty range after performing measurements over a number of occasions. Further, for example, the WTRU determines that the reported SB and/or MB target reflection detection measurement (e.g., detected RS ID resolvable paths, RS resolvable paths association to a sensing target, SB and/or MB association to a resolvable path, or the like) and/or the measurement values associated to the SB and/or MB target reflection detection are invalid or outdated based on any of the following: a change in the measured TO and/or SC location is above a configured threshold; a difference between the measured TO and/or SC location and the configured TO and/or SC location is above a configured threshold; a time interval since the last measurement occasion is greater than the validity time of the TO and/or SC configured profile; a change in the measured WTRU position and/or orientation (e.g., using RAT-dependent and/or independent methods) is above a configured threshold; a measured TO and/or SC velocity (e.g., and/or doppler) of the associated RS that is reflected from the TO and/or SC is above a configured threshold; a change in the number of the RS resolvable paths that are associated to SB and/or MB target reflection detection is above a configured threshold; a change in the TRP status; a change in the RS configuration (e.g., PRS beam ID(s), periodicity, repetition factor, time gap, comb size, number of frequency hops or the like); an uncertainty range associated with the SB and/or MB target reflection detection is above a configured threshold; an uncertainty range associated with the degree of the MB target reflection (e.g., double, triple, or the like) and/or the type of the multi-bounce target reflection (e.g., NLoS-LoS, NLoS-NLoS, or the like) is above a configured threshold; a determined association between an RS and/or an RS resolvable path and the sensing target is below a configured threshold; combinations of the same; or the like.

In one example, the WTRU is configured to update its SB and/or MB target reflection detection report based on the status of a specific TRP changing from connected to disconnected and/or disconnected to connected. In another example, the WTRU is configured to update its SB and/or MB target reflection detection report based on the status of a subset group of TRPs (e.g., determined by a threshold number or TRP IDs) changing from connected to disconnected and/or disconnected to connected.

For example, the WTRU determines to send an updated target reflection detection measurement report in aperiodic (e.g., including event-triggered reporting), periodic or semi-persistent form (e.g., over an uplink control or data channel). Further, for example, the updated target reflection detection measurement report includes at least one of the following: updated SB and/or MB target reflection detection with the corresponding updated uncertainty range; updated degree and/or type of the MB target reflection detection with the corresponding updated uncertainty range; updated RS IDs and their corresponding resolvable paths that are associated with SB and/or MB reflections from the sensing target; updated association level between the RS ID and the corresponding resolvable paths and the sensing target; updated measurements that are associated with the SB and/or MB target reflection detection measurement with the corresponding uncertainty ranges; the difference between the current uncertainty range and the previous uncertainty range calculated for previous SB and/or MB target reflection detection measurements; a reason for update; combinations of the same; or the like. Additionally, for example, the WTRU sends the change in the measured parameters (e.g., SB/MB target reflection detection, association level, or the like).

In one example, the WTRU is configured to report the invalidity of its previous SB and/or MB target reflection detection measurement to the network.

In certain representative embodiments, the WTRU reports information in connection with detection of SB and/or MB target reflection, based on reporting behavior described as follows.

For example, the WTRU is configured to perform the measurements over multiple occasions (e.g., multi-slot level based on repetition factor and/or time gap configurations). Further, for example, the WTRU determines to stop reporting on the SB and/or MB target reflection based on at least one of the following: one or more of RS reflection measurements are below a threshold over a configured period of time; a difference between the measured profiles (e.g., RS metric profile of a resolvable path, RCS profile, or the like) over multiple measurement instances is below a configured threshold; a change in the measured difference between the TO and/or SC(s) profiles and the measured profile (e.g., RS metric profile of a resolvable path, RCS profile, or the like) over multiple measurement instances is below a configured threshold; a change in the measured correlation between the TO and/or SC(s) profiles and the measured profile (e.g., RS metric profile of a resolvable path, RCS profile, or the like) over multiple measurement instances is below a configured threshold; a change in the measured TO and/or SC(s) locations over multiple measurement instances is below a configured threshold; a change in the measured TO and/or SC(s) mobility over multiple measurement instances is below a configured threshold; a measured uncertainty in SB and/or MB target reflection detection is above a configured threshold over multiple measurements instances; a measured uncertainty in the degree and/or the type of MB target reflection detection is above a configured threshold over multiple measurements instances; a change in the SB and/or MB target reflection association with the RS resolvable paths is below a configured threshold; a change in the degree and/or type of MB target reflection that is associated with RS resolvable path is below a configured threshold; an allocation of the WTRU resources (e.g., processing, computational, battery, antenna, or the like) to higher priority WTRU tasks; a termination indication received from the network; combinations of the same; or the like.

In one example, the WTRU requests to terminate reporting on the SB and/or MB target reflection based on the WTRU determining that a calculated and/or configured (e.g., by the wireless network) update time interval is below a minimum threshold, which may interfere with the scheduling of other higher priority WTRU tasks.

For example, the WTRU determines to send a report over an UL control or data channel containing the recommendation to stop reporting on the measurement procedure and at least one of the following: a termination indicator, a termination time stamp, a detailed termination reason, the latest sensing SB and/or MB target reflection, combinations of the same, or the like.

For example, the termination indicator may refer to the reason of termination. Further, for example, a termination indicator of 1 refers to an uncertainty range above a configured threshold for N measurement occasions. Additionally, for example, an indicator value of 2 refers to an allocation of WTRU resources to other higher priority tasks.

For example, the detailed termination reason includes the measured change of at least one of the SB and/or MB target reflection associations with RS resolvable paths, sensing measurements, estimated locations and/or velocities, combinations of the same, or the like over N measurement occasions. Further, for example, the WTRU reports to the network the other higher priority tasks and the priority order of the SB and/or MB target reflection detection.

For example, the latest sensing SB and/or MB target reflection includes all requested information of the one or more of the metrics used for the SB and/or MB target reflection detection measurement, the RS signal ID used for detection with the corresponding associated resolvable paths, combinations of the same, or the like.

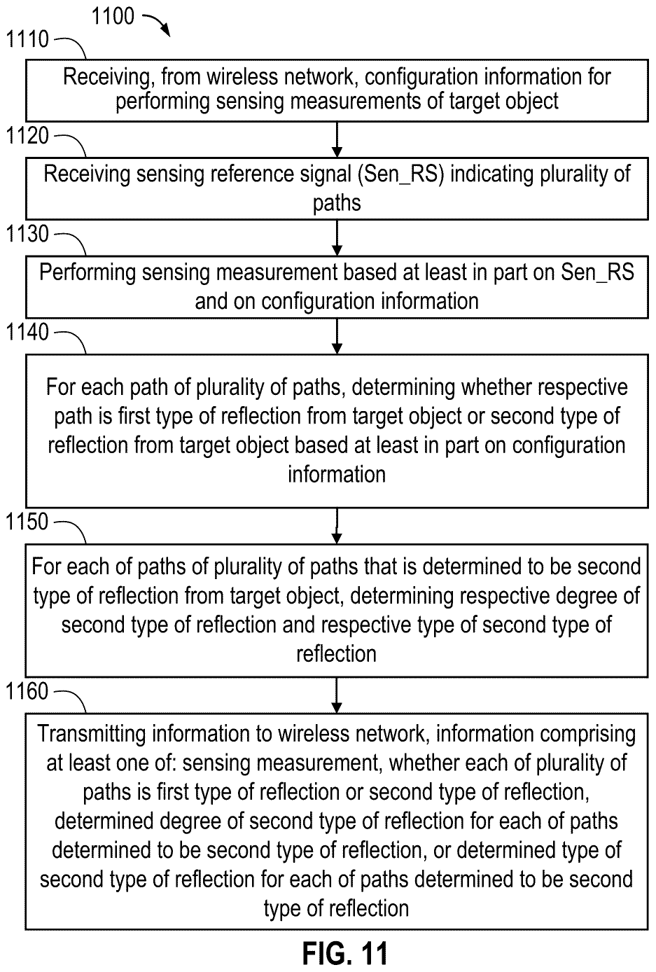

In certain representative embodiments, as shown, for example, in FIG. 11, a method 1100 is performed by a WTRU (e.g., 102, 390, 690, 790, 1090) in communication with a wireless network (e.g., core network 106, 115) for performing sensing measurements of a target object (e.g., 330, 630, 730, 1030). Also, for example, the method 1100 comprises receiving 1110, from the wireless network (e.g., core network 106, 115), configuration information for performing the sensing measurements of the target object (e.g., 330, 630, 730, 1030). Further, for example, the method 1100 comprises receiving 1120 a sensing reference signal (Sen_RS) indicating a plurality of paths. In addition, for example, the method 1100 comprises performing 1130 a sensing measurement based at least in part on the Sen_RS and on the configuration information. Moreover, for example, the method 1100 comprises for each path of the plurality of paths, determining 1140 whether the respective path is a first type of reflection from the target object (e.g., 330, 630, 730, 1030) or a second type of reflection from the target object (e.g., 330, 630, 730, 1030) based at least in part on the configuration information. Furthermore, for example, the method 1100 comprises for each of the paths of the plurality of paths that is determined to be the second type of reflection from the target object (e.g., 330, 630, 730, 1030), determining 1150 a respective degree of the second type of reflection and a respective type of the second type of reflection. Additionally, for example, the method 1100 comprises transmitting 1160 information to the wireless network (e.g., core network 106, 115), the information comprising at least one of: the sensing measurement, whether each of the plurality of paths is the first type of reflection or the second type of reflection, the determined degree of the second type of reflection for each of the paths determined to be the second type of reflection, or the determined type of the second type of reflection for each of the paths determined to be the second type of reflection.

In certain representative embodiments, a WTRU (e.g., 102, 390, 690, 790, 1090) is provided in communication with a wireless network (e.g., core network 106, 115). For example, the WTRU (e.g., 102, 390, 690, 790, 1090) is configured to perform sensing measurements of a target object (e.g., 330, 630, 730, 1030). Also, for example, the WTRU (e.g., 102, 390, 690, 790, 1090) comprises a processor (e.g., 118). Further, for example, the processor (e.g., 118) is configured to receive 1110, from the wireless network (e.g., core network 106, 115), configuration information for performing the sensing measurements of the target object (e.g., 330, 630, 730, 1030). In addition, for example, the processor (e.g., 118) is configured to receive 1120 a sensing reference signal (Sen_RS) indicating a plurality of paths. Moreover, for example, the processor (e.g., 118) is configured to perform 1130 a sensing measurement based at least in part on the Sen_RS and on the configuration information. Furthermore, for example, the processor (e.g., 118) is configured to for each path of the plurality of paths, determine 1140 whether the respective path is a first type of reflection from the target object (e.g., 330, 630, 730, 1030) or a second type of reflection from the target object (e.g., 330, 630, 730, 1030) based at least in part on the configuration information. Additionally, for example, the processor (e.g., 118) is configured to for each of the paths of the plurality of paths that is determined to be the second type of reflection from the target object (e.g., 330, 630, 730, 1030), determine 1150 a respective degree of the second type of reflection and a respective type of the second type of reflection. Still further, for example, the processor (e.g., 118) is configured to transmit 1160 information to the wireless network (e.g., core network 106, 115), the information comprising at least one of: the sensing measurement, whether each of the plurality of paths is the first type of reflection or the second type of reflection, the determined degree of the second type of reflection for each of the paths determined to be the second type of reflection, or the determined type of the second type of reflection for each of the paths determined to be the second type of reflection.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-ID. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU) in communication with a wireless network for performing sensing measurements of a target object, the method comprising:
receiving, from the wireless network, configuration information for performing the sensing measurements of the target object;
receiving a sensing reference signal (Sen_RS) indicating a plurality of paths;
performing a sensing measurement based at least in part on the Sen_RS and on the configuration information;
for each path of the plurality of paths, determining whether the respective path is a first type of reflection from the target object or a second type of reflection from the target object based at least in part on the configuration information;
for each of the paths of the plurality of paths that is determined to be the second type of reflection from the target object, determining a respective degree of the second type of reflection and a respective type of the second type of reflection; and
transmitting information to the wireless network, the information comprising at least one of: the sensing measurement, whether each of the plurality of the paths is the first type of reflection or the second type of reflection, the determined degree of the second type of reflection for each of the paths determined to be the second type of reflection, or the determined type of the second type of reflection for each of the paths determined to be the second type of reflection.

2. The method of claim 1, wherein the configuration information comprises:
metrics and conditions to determine a reference signal (RS) association type;
a measurement window in a time domain and/or a spatial domain for the performing the sensing measurement; and
scatterer assistance information.

3. The method of claim 2, wherein the measurement window is configured in the time domain or the spatial domain.

4. The method of claim 2, wherein:
the first type of reflection is a single-bounce line-of-sight (LoS) reflection,
the second type of reflection is a multi-bounce non-line-of-sight (NLoS) reflection, and
the metrics and the conditions to determine the RS association type comprises thresholds for the single-bounce LoS reflection and/or the multi-bounce NLoS reflection.

5. The method of claim 2, wherein the scatterer assistance information comprises scatterer object location, average radar cross-section (RCS), average RCS profile, and multipath delay (MD) profile.

6. The method of claim 1, wherein:
the first type of reflection is a single-bounce line-of-sight (LoS) reflection,
the second type of reflection is a multi-bounce non-line-of-sight (NLoS) reflection, and
the determining whether the respective path is the single-bounce LoS reflection from the target object or the multi-bounce NLoS reflection from the target object is based at least in part on at least one of:
a difference between a profile of the Sen_RS and a profile of the target object;
a difference between the profile of the Sen_RS and a combined profile of the target object and a scatterer;
a correlation between the profile of the Sen_RS and the profile of the target object; or
a correlation between the profile of the Sen_RS and the combined profile of the target object and the scatterer.

7. The method of claim 1, wherein:
the first type of reflection is a single-bounce line-of-sight (LoS) reflection,
the second type of reflection is a multi-bounce non-line-of-sight (NLoS) reflection, and
the information transmitted to the wireless network further comprises at least one of:
measurements of the Sen_RS within a measurement window;
measurement comparison results at configured angles of arrival (AoAs) between a profile of the Sen_RS and a profile of the target object and/or a combined profile of the target object and a scatterer; or
resource IDs of the Sen_RS associated with the single-bounce LoS reflection and/or the multi-bounce NLoS reflection from the target object.

8. The method of claim 1, wherein:
the first type of reflection is a single-bounce line-of-sight (LoS) reflection,
the second type of reflection is a multi-bounce non-line-of-sight (NLoS) reflection, and
a degree of the multi-bounce NLoS reflection is determined to be at least one of a double bounce reflection, a triple bounce reflection, or a higher-order bounce reflection.

9. The method of claim 1, wherein:
the first type of reflection is a single-bounce line-of-sight (LoS) reflection,
the second type of reflection is a multi-bounce non-line-of-sight (NLoS) reflection, and
the type of the multi-bounce NLoS path is determined to be at least one of a NLoS-LOS path, a LoS-NLoS path, or a NLoS-NLoS path.

10. The method of claim 1, wherein the sensing measurement comprises at least one of a reference signal received power (RSRP), a reference signal received power per path (RSRPP), a reference signal carrier power (RSCP), a reference signal received quality (RSRQ), a signal to interference plus noise ratio (SINR), a channel quality indicator (CQI), a channel impulse response (CIR), a rank indicator (RI), a precoding matrix indicator (PMI), or a timing advance (TA).

11. A wireless transmit/receive unit (WTRU) in communication with a wireless network, wherein the WTRU is configured to perform sensing measurements of a target object, the WTRU comprising a processor configured to:
receive configuration information from the wireless network for performing the sensing measurements of the target object;
receive a sensing reference signal (Sen_RS) indicating a plurality of paths;
perform a sensing measurement based at least in part on the Sen_RS and on the configuration information;
determine, for each path of the plurality of paths, whether the respective path is a first type of reflection from the target object or a second type of reflection from the target object based at least in part on the configuration information;
determine, for each of the paths of the plurality of paths that is determined to be the second type of reflection from the target object, a respective degree of second type of reflection and a respective type of the second type of reflection; and
transmit information to the wireless network, the information comprising at least one of: the sensing measurement, whether each of the plurality of paths is the first type of reflection or the second type of reflection, the determined degree of second type of reflection for each of the paths determined to be the second type of reflection, or the determined type of the second type of reflection for each of the paths determined to be the second type of reflection.

12. The WTRU of claim 11, wherein the configuration information comprises:
metrics and conditions to determine a reference signal (RS) association type;
a measurement window in a time domain and/or a spatial domain for performing the sensing measurement; and
scatterer assistance information.

13. The WTRU of claim 12, wherein the measurement window is configured in the time domain or the spatial domain.

14. The WTRU of claim 12, wherein:
the first type of reflection is a single-bounce line-of-sight (LoS) reflection,
the second type of reflection is a multi-bounce non-line-of-sight (NLoS) reflection, and
the metrics and the conditions to determine the RS association type comprise thresholds for the single-bounce LoS reflection and/or the multi-bounce NLoS reflection.

15. The WTRU of claim 12, wherein the scatterer assistance information comprises scatterer object location, average radar cross-section (RCS), average RCS profile, and multipath delay (MD) profile.

16. The WTRU of claim 11, wherein:
the first type of reflection is a single-bounce line-of-sight (LoS) reflection,
the second type of reflection is a multi-bounce non-line-of-sight (NLoS) reflection, and
for the processor configured to determine whether the respective path is the single-bounce LoS reflection from the target object or the multi-bounce NLoS reflection from the target object, the determination is based at least in part on at least one of:
a difference between a profile of the Sen_RS and a profile of the target object;
a difference between the profile of the Sen_RS and a combined profile of the target object and a scatterer;
a correlation between the profile of the Sen_RS and the profile of the target object; or
a correlation between the profile of the Sen_RS and the combined profile of the target object and the scatterer.

17. The WTRU of claim 11, wherein:
the first type of reflection is a single-bounce line-of-sight (LoS) reflection,
the second type of reflection is a multi-bounce non-line-of-sight (NLoS) reflection, and
the information transmitted to the wireless network further comprises at least one of:
measurements of the Sen_RS within a measurement window;
measurement comparison results at configured angles of arrival (AoAs) between a profile of the Sen_RS and a profile of the target object and/or a combined profile of the target object and a scatterer; or
resource IDs of the Sen_RS associated with the single-bounce LoS reflection and/or the multi-bounce NLoS reflection from the target object.

18. The WTRU of claim 11, wherein:
the first type of reflection is a single-bounce line-of-sight (LoS) reflection,
the second type of reflection is a multi-bounce non-line-of-sight (NLoS) reflection, and
a degree of the multi-bounce NLoS reflection is determined to be at least one of a double bounce reflection, a triple bounce reflection, or a higher-order bounce reflection.

19. The WTRU of claim 11, wherein:
the first type of reflection is a single-bounce line-of-sight (LoS) reflection,
the second type of reflection is a multi-bounce non-line-of-sight (NLoS) reflection, and
the type of the multi-bounce NLoS path is determined to be at least one of a NLoS-LOS path, a LoS-NLoS path, or a NLoS-NLoS path.

20. The WTRU of claim 11, wherein the sensing measurement comprises at least one of a reference signal received power (RSRP), a reference signal received power per path (RSRPP), a reference signal carrier power (RSCP), a reference signal received quality (RSRQ), a signal to interference plus noise ratio (SINR), a channel quality indicator (CQI), a channel impulse response (CIR), a rank indicator (RI), a precoding matrix indicator (PMI), or a timing advance (TA).
